(19) United States
(12) Patent Application Publication
(10) Pub. No.: US 2026/0253993 A1
(43) Pub. Date: Aug. 27, 2026

(54) Battery Assembly and Battery Pack Including the Same

(71) Applicant: LG Energy Solution, Ltd., Seoul (KR)

(72) Inventors: Inhyeok Kim, Daejeon (KR); Minyong Jung, Daejeon (KR); Burn Choi, Daejeon (KR); Namki Jeon, Daejeon (KR)

(73) Assignee: LG Energy Solution, Ltd., Seoul (KR)

(21) Appl. No.: 19/551,300

(22) Filed: Feb. 26, 2026

(30) Foreign Application Priority Data
Feb. 27, 2025 (KR) 10-2025-0025821
Jul. 21, 2025 (KR) 10-2025-0098203

(51) Int. Cl. H01M 10/6567; H01M 10/613; H01M 10/625; H01M 10/6556; H01M 50/249; H01M 50/289; H01M 50/505

(52) U.S. Cl. CPC H01M 10/6567; H01M 10/613; H01M 10/625; H01M 10/6556; H01M 50/249; H01M 50/289; H01M 50/505

(57) ABSTRACT

A battery assembly includes a plurality of battery cells received in an interior space of a cell frame with at least one busbar member electrically connected to a terminal of an associated battery cell. A coolant circulates through the interior space of the cell frame along a cooling flow path in direct contact with the battery cells. At least some of the coolant is directed along a terminal cooling flow path into direct contact with the busbar member and the terminal. A hole for connecting the cooling flow path to the terminal cooling flow path is located proximate to an inlet that supplies the coolant into the cell frame.

### CROSS-REFERENCE TO RELATED APPLICATIONS

This application claims priority from Korean Patent Application No. 10-2025-0025821, filed on Feb. 27, 2025, and Korean Patent Application No. 10-2025-0098203, filed on Jul. 21, 2025, the entire disclosures of which are hereby incorporated herein by reference.

### TECHNICAL FIELD

The present disclosure relates to a battery assembly and a battery pack including the same, and more particularly, to a battery assembly having improved cooling performance and a battery pack including the same.

### BACKGROUND

Secondary batteries are frequently used in various products and exhibit superior electrical properties, such as high energy density, etc., are commonly used not only in portable devices but also in electric vehicles (EVs), hybrid electric vehicles (HEVs), plug-in hybrid electric vehicles (P-HEVs), and the like, driven by electrical power sources. Such secondary batteries are widely used as a novel energy source due to their environmental friendliness and energy efficiency, in that they provide the advantage of remarkably reducing the use of fossil fuels, and also generating no by-products resulting from their use of energy.

The types of secondary batteries currently include a lithium ion battery, a lithium polymer battery, a nickel cadmium battery, a nickel hydride battery, a nickel zinc battery, and the like. An operating voltage of a unit battery cell of a secondary battery, is typically about 2.5V to 4.5V. Therefore, when an output voltage higher than the operating voltage is required, a plurality of battery cells may be connected in series to configure a battery pack. In addition, depending on the charge/discharge capacity required for the battery pack, a plurality of battery cells may also be connected in parallel to configure a battery pack. Thus, the number of battery cells included in the battery pack may be variously set in accordance with the required output voltage or charge/discharge capacity.

Meanwhile, when a plurality of battery cells are connected in series/parallel to configure a battery pack, a common method employs a process of first making a battery assembly that includes a plurality of battery cells and storing it in a module case to produce a battery module. Then one or more battery modules are gathered and other components may be added thereto to configure a battery pack. Alternatively, a plurality of battery cells may be directly disposed in a pack frame (without being contained in a module case) and adding other components thereto to configure a battery pack.

Since such battery cells are constituted of secondary batteries that can be recharged and discharged, such high-output, large-capacity secondary batteries generate a large amount of heat in a charge and discharge process. In such case, the heat emitted from the plurality of battery cells may be accumulated in a relatively small space, which may raise the temperature of the battery module quickly and severely. In other words, a battery module including a large number of battery cells can obtain high output, but it is not easy to remove heat generated from the battery cells during charging and discharging. When the heat dissipation of the battery cells is not properly performed, deterioration of the battery cells is accelerated, the lifetime is shortened, and the possibility of explosion or ignition increases.

Moreover, in the case of a vehicle battery pack, it is frequently exposed to direct sunlight and may be placed under high-temperature conditions such as summer or desert areas. Further, since a plurality of battery modules may be concentratedly disposed to increase the mileage of the vehicle, any flames or heat generated in any one of the battery cells can easily propagate to adjacent battery cells, which may eventually lead to ignition or explosion of the battery pack itself.

Conventionally, such battery assemblies have adopted a bottom cooling or side cooling system, in which a heat sink is mounted in the module case of the battery module to provide cooling. However, in the case of such cooling type battery modules, heat generated in the battery cells is typically transferred to a heat sink on one side of the module case and cooled, so that a heat transfer path may not be easily provided on the other side of the module case. Thereby, they have a limitation in that a temperature deviation between one end and the other end of the battery assembly may be deepened, or the cooling efficiency may not be satisfactory as a whole. If the temperature deviation is not resolved, it could cause safety and durability issues for the battery module. If the cooling efficiency is not good, it may accelerate deterioration of the battery cells, or it may not be possible to quickly address when thermal runaway occurs in some battery cells, which could lead to thermal runaway propagation. This may then lead to disasters such as ignition and explosion of a battery module or a battery pack containing the same, which may cause not only property damage but also safety problems.

In order to address these problems, a system in which the inside of the battery pack is filled with a cooling water or a cooling oil to directly cool the battery cells may be used, without using bottom cooling or side cooling. That is, in order to effectively cool a high-capacity battery pack, a cooling system in which a coolant directly cools the battery cells inside the battery assembly may be used.

### SUMMARY

### Technical Problem

It is an object of the present disclosure to provide a battery assembly having improved cooling performance in a cooling structure in which a coolant cools battery cells, and a battery pack including the same.

However, the technical objects to be solved by aspects of the present disclosure are not limited to the above-mentioned objects, and can be variously expanded within the scope of the technical idea included in the present disclosure.

### Technical Solution

According to an aspect of the present disclosure, a battery assembly is provided. Such battery assembly includes a plurality of battery cells received in an interior space defined by a cell frame, where at least one busbar member is electrically connected to a terminal of an associated one of the battery cells. The interior space is configured to receive a coolant circulating therethrough such that the coolant is in direct contact with the battery cells. Preferably, the cell frame is configured such that at least some of the coolant is directed into direct contact with at least one of the busbar member or the associated terminal.

In some aspects, the cell frame may be configured such that the coolant is directed into direct contact with both the busbar member and the associated terminal.

In an aspect, the cell frame may include a top cell frame on which the busbar member is seated and a cell cover located at an upper part of the top cell frame.

In an aspect, a space may be defined between the cell cover and the top cell frame, where such space provides a terminal cooling flow path configured to direct the coolant into direct contact with the busbar member or the associated terminal.

In an aspect, the space between the cell cover and the top cell frame may include segments of an adhesive material defining channels therebetween, where such channels define the terminal cooling flow path.

In an aspect, the interior space of the cell frame may be configured to direct the coolant into direct contact with the battery cells along a cooling flow path, and the interior space of the cell frame may be configured such that the cooling flow path and the terminal cooling flow path may be connected to each other.

In an aspect, a terminal cooling hole for connecting the cooling flow path and the terminal cooling flow path may extend through the top cell frame.

In an aspect, the cell cover may comprise a protruding part formed on one surface of the cell cover, and the protruding part may protrude toward a portion where the busbar member and the associated terminal are connected.

In an aspect, the protruding part may press at least a part of the portion where the busbar member and the associated terminal are connected.

In an aspect, the protruding part may be fixed by an adhesive to at least a part of the portion where the busbar member and the associated terminal are connected.

In an aspect, the cell frame may include an inlet through which the coolant flows into the interior space of the cell frame and an outlet through which the coolant is discharged to the outside of the cell frame, where the coolant follows a flow path between the inlet and the outlet.

In an aspect, the cell frame may be configured to direct the coolant to flow along a longitudinal dimension of the cell frame from the inlet.

In an aspect, the cell frame may include a top cell frame on which the busbar member is seated and a cell cover located at an upper part of the top cell frame. A space may be defined between the cell cover and the top cell frame, where that space provides a terminal cooling flow path configured to direct the coolant into direct contact with the busbar member or the associated terminal. The top cell frame may include a terminal cooling hole extending through it to divert some of the coolant from the flow path to the terminal cooling flow path through that terminal cooling hole. In at least one of such aspects, the terminal cooling hole may be positioned no further from the inlet along the longitudinal dimension of the cell frame than 25% of a length of the cell frame along the longitudinal dimension. In at least another one of such aspects, the terminal cooling hole may have a longitudinal position along the longitudinal dimension of the cell frame, where that longitudinal position is between the inlet and a closes one of the batteries to the inlet along the longitudinal dimension.

In an aspect, the coolant circulating through the interior space of the cell frame may flow within two regions of the interior space that are partitioned from one another.

In an aspect, the two regions of the interior space of the cell frame may be partitioned along the longitudinal dimension of each of the plurality of battery cells, such that a first of the regions is positioned closer to the terminal of each of the battery cells along their longitudinal dimensions, and a second of the regions is positioned farther from the terminal of each of the battery cells along their longitudinal dimensions.

In an aspect, each of the first and second regions of the interior space of the cell frame may include a respective inlet and a respective outlet. The coolant may flow into the first and second regions from outside of the cell frame via the respective inlets, and the coolant may be discharged to the outside of the cell frame via the respective outlets. The coolant flowing through the first region and the second flow region may flow along opposite directions to one another.

In an aspect, both of the first and second regions of the interior space of the cell frame may communicate via a respective passage with a third region partitioned from the first and second regions by a top cell frame. At least some of the coolant can be directed from the first and second regions to the third region via the respective passages so that the coolant comes into direct contact with the busbar member or the associated terminal.

In an aspect, the battery cells received within the cell frame may be mounted directly to a vehicle or chassis via the cell frame of the battery assembly.

According to another aspect of the present disclosure, a battery pack is provided. Such battery pack includes at least one battery assembly as described above, as well as a pack frame that receives the battery assembly. The pack frame may be opened on one side, and a pack cover may cover the opened side of the pack frame.

### Advantageous Effects

According to aspects of the present disclosure, since the coolant is in direct contact with the battery cells, as well as the terminals of the battery cells and the busbar members electrically connected to the terminals, and the coolant thereby cools those components, the cooling performance of the battery assembly can be further improved.

The effects of the present disclosure are not limited to the effects mentioned above, and additional other effects not mentioned above will be clearly understood from the following description by those skilled in the art.

### BRIEF DESCRIPTION OF THE DRAWINGS

FIG. 1 is a perspective view showing a battery assembly according to an aspect of the present disclosure.

FIG. 2 is a top plan view showing the battery assembly of FIG. 1 as viewed along the −z-axis direction towards the xy-plane.

FIG. 3 is an exploded perspective view of the battery assembly of FIG. 1.

Parts (a) and (b) of FIG. 4 are a perspective view and a side elevation view, respectively, of a battery cell according to an aspect of the present disclosure.

FIG. 5 is a cross-sectional view of the bottom portion of the battery cell, showing a cross section taken along the cutting line C-C′ of part (a) of FIG. 4.

FIG. 6 is a side cross-sectional view of a battery cell according to an aspect of the present disclosure.

FIG. 7 is a partial perspective view of the battery assembly according to an aspect of the present disclosure.

FIG. 8 is a cross-sectional view showing a cross section taken along the cutting line A-A′ of FIG. 2.

FIG. 9 is a partially enlarged cross-sectional view showing region “D” of FIG. 8.

FIG. 10 is a partially enlarged cross-sectional view showing region “E” of FIG. 8.

FIG. 11 is an enlarged cross-sectional view showing a portion of the cross section taken along the cutting line B-B′ of FIG. 2.

FIG. 12 is a partial perspective view showing a state in which the cell cover is removed from a battery assembly according to an aspect of the present disclosure.

FIGS. 13 and 14 are a cross-sectional perspective view and a cross-sectional view, respectively, showing the cross sections taken along the cutting line F-F′ of FIG. 12.

FIG. 15 is a partial perspective view showing a state in which the cell cover is included in a battery assembly according to an aspect of the present disclosure.

FIG. 16 is a cross-sectional view showing a state taken along the cutting line G-G′ of FIG. 15.

FIG. 17 is a cross-sectional perspective view of a portion of a battery assembly according to an aspect of the present disclosure.

FIG. 18 is a cross-sectional view of a portion of a battery assembly according to another aspect of the present disclosure.

FIG. 19 is a cross-sectional view showing a state taken along the cutting line H-H′ of FIG. 2.

FIG. 20 is an enlarged partial view of a section “I” of FIG. 19.

FIG. 21 is a perspective view showing a cell cover according to an aspect of the present disclosure.

FIG. 22 is an exploded perspective view showing a top cell frame, a busbar assembly, and a cell cover according to an aspect of the present disclosure.

FIG. 23 is an exploded perspective view showing a top cell frame and a first sealing member according to an aspect of the present disclosure.

FIG. 24 is a perspective view showing a top cell frame according to an aspect of the present disclosure.

FIG. 25 is a perspective cross-sectional view showing a cross section taken along the cutting line J-J′ of FIG. 24.

FIG. 26 is an exploded perspective view showing a middle cell frame and a second sealing member according to an aspect of the present disclosure.

FIG. 27 is a perspective view showing a middle cell frame according to an aspect of the present disclosure.

FIG. 28 is a cross-sectional perspective view showing a cross section taken along the cutting line K-K′ of FIG. 27.

FIG. 29 is an exploded perspective view showing battery cells, a third sealing member, and a bottom cell frame according to an aspect of the present disclosure.

FIG. 30 is a perspective view showing a bottom cell frame according to an aspect of the present disclosure.

FIG. 31 is an exploded perspective view showing the bottom cell frame of FIG. 30.

FIG. 32 is a cross-sectional view showing a cross section taken along the cutting line L-L′ of FIG. 30.

FIGS. 33 and 34 are exploded perspective views of a battery pack according to an aspect of the present disclosure.

FIG. 35 is a perspective view showing a battery assembly according to another aspect of the present disclosure.

FIG. 36 is a side elevation view showing the battery assembly of FIG. 35.

FIG. 37 is a front elevation view showing a state of the battery assembly of FIG. 35, viewed from an angle different from that of FIG. 36.

FIG. 38 is a top plan view showing a state of the battery assembly of FIG. 35, viewed from an angle different from that of FIGS. 36 and 37.

FIG. 39 is an exploded perspective view showing the battery assembly of FIG. 35.

FIG. 40 is a cross-sectional view showing a cross section taken along the cutting line A-A′ of FIG. 37.

FIG. 41 is an enlarged cross-sectional view showing a region of FIG. 40.

FIG. 42 is a perspective view showing the partially enlarged cross-section of FIG. 41.

FIG. 43 is a perspective view showing a portion of a cross section taken along the cutting line B-B′ of FIG. 37.

FIG. 44 is a top plan view of the portion of the cross section of FIG. 43.

FIG. 45 is a cross-sectional view showing a cross section taken along the cutting line C-C′ of FIG. 38.

FIG. 46 is a perspective view showing a partially enlarged cross-section of one end of the battery assembly 100 taken along the cutting line D-D′ of FIG. 37 and the cutting line C-C′ of FIG. 38.

FIG. 47 is a perspective view showing a partially enlarged cross-section of another end of the battery assembly 100, opposite to the end of the battery assembly 100 shown in FIG. 46, taken along the cutting line C-C′ of FIG. 38.

FIG. 48 is a cross-sectional view showing a cross section taken along the cutting line E-E′ of FIG. 38.

FIG. 49 is a partial cross-sectional perspective view of the battery assembly of FIG. 48.

FIG. 50 is a cross-sectional view showing a cross section taken along the cutting line F-F′ of FIG. 38.

FIG. 51 is a partial perspective view showing a state in which the top frame is removed in a battery assembly according to an aspect of the present disclosure.

FIG. 52 is a partial perspective view showing a state in which the top frame is removed in a battery assembly taken along the cutting line E-E′ of FIG. 38.

FIG. 53 is a side schematic view illustrating coolant flow paths in a battery assembly according to another aspect of the present disclosure.

FIG. 54 is an exploded perspective view of a battery assembly according to another aspect of the present disclosure, illustrating the cell cover separated from the top cell frame.

FIG. 55 is a top plan view of an upper part of the top cell frame and busbar assembly at one longitudinal end of the battery assembly of FIG. 54.

FIG. 56 is a top plan view of an upper part of the top cell frame and busbar assembly of the battery assembly of FIG. 54, showing the opposite longitudinal end to that shown in FIG. 55.

FIG. 57 is an enlarged side cross-sectional view of the battery assembly of FIG. 54, showing a region like that illustrated in FIG. 20.

### DETAILED DESCRIPTION

Hereinafter, with reference to the accompanying drawings, various aspects of the present disclosure will be described in detail to the extent that one of ordinary skill in the art can readily practice the claimed invention. The present disclosure may be implemented in various different forms, however, and thus it is not limited to the aspects described herein.

In order to clearly describe the present disclosure, descriptions of parts unrelated to the description of the present disclosure will be omitted, and the same or similar components throughout the description will be denoted with the same reference numerals.

Further, in the drawings, the sizes and thicknesses of each element are arbitrarily illustrated for convenience of description, and the present disclosure is not necessarily limited to those illustrated in the drawings. In the drawings, the thickness of layers, areas, etc. may be exaggerated for clarity. Moreover, for convenience of description, the thicknesses of a part and a region may be shown in the drawings to be exaggerated.

Further, it will be understood that when an element such as a layer, film, region, or plate is referred to as being “on” or “above” another element, it can be directly on the other element or intervening elements may also be present. In contrast, when an element is referred to as being “directly on” another element, it means that other intervening elements are not present. Further, a certain part being located “above” or “on” a reference portion means the certain part being located above or below the reference portion, and it does not mean that the certain part is specifically “above” or “on” in an opposite direction with respect to the direction of gravity.

Throughout the descriptions herein, when a certain part “includes” a component, this does not indicate that the certain part excludes other components, but rather indicates that the part may further include other components, unless otherwise defined.

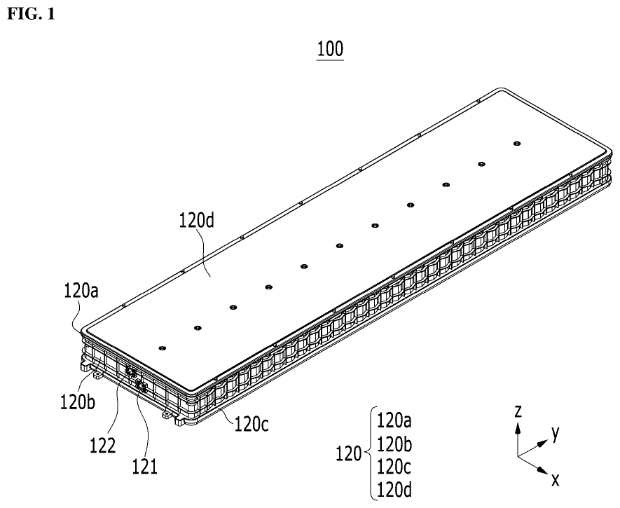

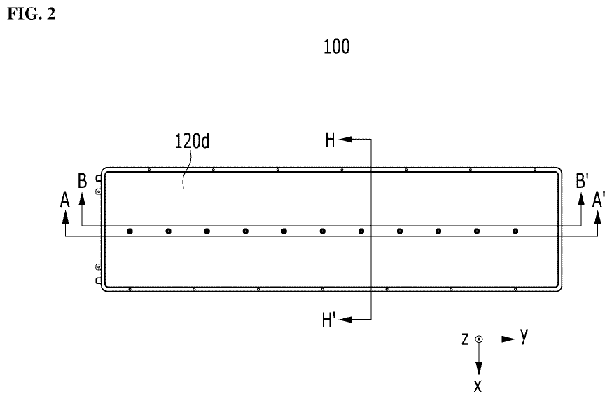

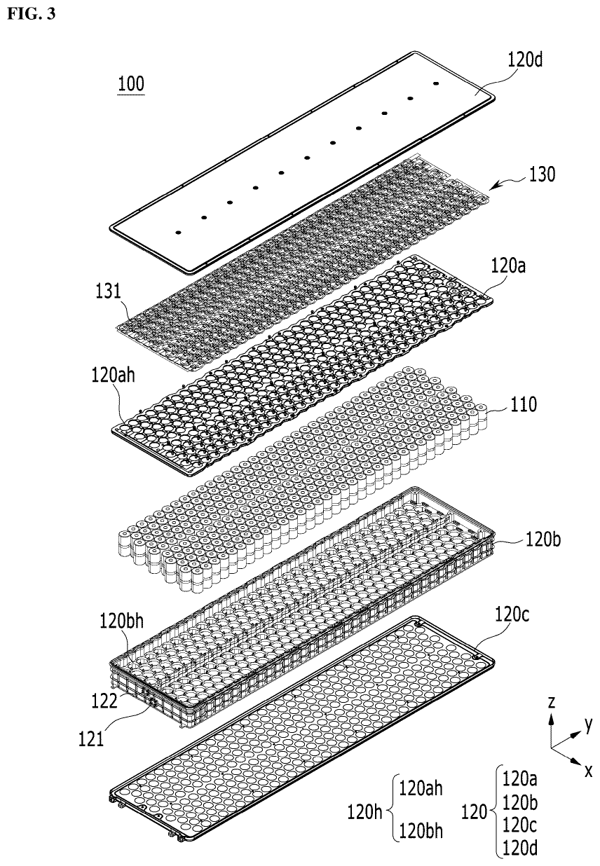

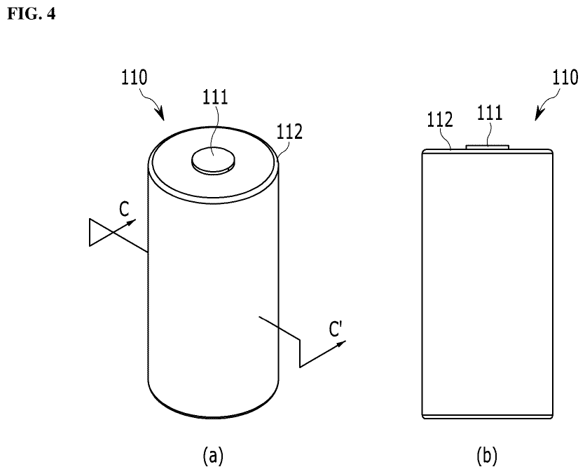

FIG. 1 is a perspective view showing a battery assembly according to an aspect of the present disclosure. FIG. 2 is a top plan view showing the battery assembly of FIG. 1 as viewed along the −z-axis direction towards the xy-plane. FIG. 3 is an exploded perspective view of the battery assembly of FIG. 1.

Referring to FIGS. 1 to 3, the battery assembly 100 according to an aspect of the present disclosure includes: a plurality of battery cells 110; and a cell frame 120 in which the plurality of battery cells 110 are stored. A cooling flow path through which coolant flows while being in contact with at least a part of the battery cells 110 may be provided inside the cell frame 120. Specific details regarding the cooling flow path will be described below.

In the battery assembly 100, a coolant circulates through the inside of the cell frame 120 while being in direct contact with the battery cells 110. That is, the battery assembly 100 according to this aspect employs a system in which a coolant directly cools the exterior surfaces of the battery cells. In the present disclosure, at least a part of the battery cells 110 may be cooled by such direct contact with the coolant. That is, in an aspect, a portion of the outer surfaces of the battery cells 110 may be in direct contact with the coolant, and in another aspect, the entire outer surfaces of the battery cells 110 may be in direct contact with the coolant.

The cell frame 120 may include an inlet port 121 through which the coolant enters the cell frame (so as to flow along the cooling flow path and come into direct contact with the battery cells 110), and the cell frame 120 includes an outlet port 122 through which the coolant is discharged from the cell frame.

First, the battery cells 110 according to this aspect will be specifically described below. The battery cells 110 according to this aspect may be any type of secondary battery, such as a prismatic, cylindrical, or pouch-shaped battery cell. However, the example battery cell 110 described below is a cylindrical cell.

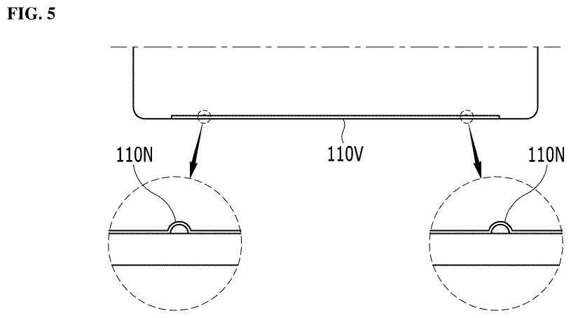

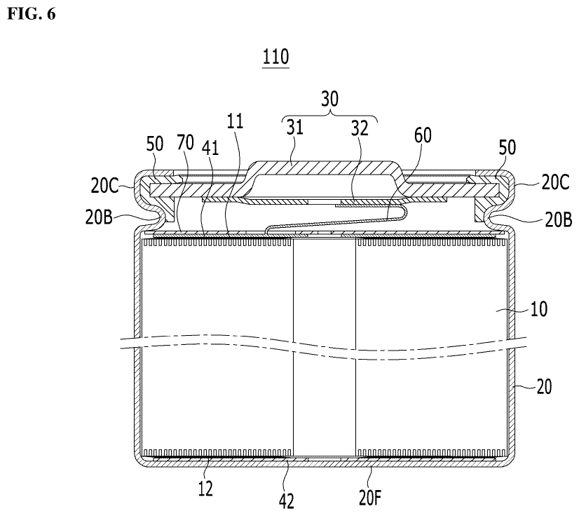

Parts (a) and (b) of FIG. 4 are a perspective view and a side elevation view of a battery cell, respectively, according to an aspect of the present disclosure. FIG. 5 is a cross-sectional view of the bottom portion of the battery cell, showing a cross section taken along the cutting line C-C′ of part (a) of FIG. 4. FIG. 6 is a side cross-sectional view of a battery cell according to an aspect of the present disclosure.

Referring to FIGS. 4 to 6, the battery cell 110 according to this aspect may be a cylindrical cell, and may have a vent part 110V. The vent part 110V collectively refers to a member or mechanism provided in the battery cell 110 so as to be able to discharge venting gas or the like from inside the battery cell 110. Further, each battery cell 110 may include terminal parts 111, 112, including a first terminal part 111 and a second terminal part 112, which may be positive and negative electrode terminals, respectively. However, the polarities of the first and second terminal parts 111, 112 may be reversed in other aspects.

In an aspect, the battery cell 110 may be a cylindrical battery cell. Specifically, the battery cell 110 may include an electrode assembly 10; a battery can 20 that contains the electrode assembly 10 within it and has an opened upper part; and a cap assembly 30 that is coupled to the opened upper part of the battery can 20. A gasket 50 may be interposed between the battery can 20 and the cap assembly 30. An example structure of the battery cells 110 will be described below, but the battery cells of the present disclosure are not limited to such a structure.

The battery can 20 according to this aspect may be a cylindrical case having an opened upper part, may receive the electrode assembly 10 and an electrolytic solution (not shown) in an internal storage space, and may include a metal material such as aluminum (Al).

The cap assembly 30 according to this aspect may include a top cap 31 having a plate shape, and a connecting plate 32 electrically and mechanically coupled to the top cap 31. The top cap 31 may include a metal material having electrical conductivity, and may cover the opened upper part of the battery can 20. The top cap 31 may be electrically connected to the first segment 11, which is in turn electrically connected to the first electrode of the electrode assembly 10. At the same time, the top cap 31 may be electrically insulated from the battery can 20 by a gasket 50. Therefore, the cap assembly 30 according to this aspect including the top cap 31 may function as a first terminal part 111, which is an external terminal of the first electrode included in the electrode assembly 10.

The electrical connection between the top cap 31 and the first segment 11 is specifically described. The battery cell 110 according to this aspect may further comprise a first current collecting plate 41 located along the upper part of the electrode assembly 10. The first current collecting plate 41 may include a conductive metal material such as aluminum, copper, steel, nickel, etc., and may be electrically connected to the first segments 11 of the electrode assembly 10. The electrical connection may be performed through weld-joining. A lead 60 may be connected to such a first current collecting plate 41. The lead 60 may extend upwardly from the electrode assembly 10 and be connected to the connecting plate 32. In other aspects, the lead 60 may be directly coupled to the lower surface of the top cap 31. The coupling between the lead 60 and other components may be performed through welding. In addition, the first current collecting plate 41 may be formed integrally with the lead 60. In such case, the lead 60 may have a long plate-like shape that extends outward from a vicinity of the central part of the first current collecting plate 41.

The first current collecting plate 41 may be provided with a plurality of projections and recesses (not shown) formed along its lower surface and oriented radially. In the case where the radial projections and recesses are provided, the first current collecting plate 41 may be pressed to press-fit the projections and recesses into the bent first segments 11. The coupling between the first current collecting plate 41 and the first segments 11 may be performed, for example, by laser welding. Laser welding may be performed by partially melting a base material of the first current collecting plate 41. In modified aspects, welding between the first current collecting plate 41 and the first segments 11 may be performed by interposing a solder therebetween. In such case, the solder may have a lower melting point than the first current collecting plate 41 and the first segments 11. Laser welding can be replaced by resistance welding, ultrasonic welding, spot welding, etc.

The battery cell 110 according to this aspect may further comprise a second current collecting plate 42 located along a lower part of the electrode assembly 10. Specifically, the second current collecting plate 42 may be located between the electrode assembly 10 and the bottom part 20F of the battery can 20. The second current collecting plate 42 may include a conductive metal material such as aluminum, copper, steel, nickel, etc., and may be electrically connected to the second segments 12 of the electrode assembly 10. One surface of the second current collecting plate 42 may be coupled to the second segments 12, and the opposite surface of the second current collecting plate 42 may be coupled to the bottom part 20F of the battery can 20. Weld-joining may be utilized for coupling the second current collecting plate 42 to the bottom part 20F of the battery can 20. Thereby, the battery can 20 according to this aspect can function as a second terminal part 112, which is an external terminal of the second electrode included in the electrode assembly 10.

The secondary battery according to this aspect may include an insulating plate 70. The insulating plate 70 may cover the first current collecting plate 41. The insulating plate 70 covers the first current collecting plate 41 on the upper surface of the first current collecting plate 41, and thereby can block the first current collecting plate 41 from being in contact with the battery can 20, particularly the beading part 20B of the battery can 20, which will be described later. The insulating plate 70 may also be provided with a separate lead hole so that a lead 60 extending upward from the first current collecting plate 41 can extend therethrough. The lead 60 may extend upward through the lead hole of the insulating plate 70 and be coupled to the lower surface of the connecting plate 32 or the lower surface of the top cap 31.

The circumferential edge region of the insulating plate 70 can be interposed between the first current collecting plate 41 and the beading part 20B of the battery can 20 so as to secure a coupling body that is positioned between the electrode assembly 10 and the first current collecting plate 41 by limiting movement of the coupling body along the axial dimension of the electrode assembly 10, which improves the stability of the assembled secondary battery. The insulating plate 70 can be made of a polymer resin having insulating properties. In an aspect, the insulating plate 70 can include one or more materials selected from the group consisting of polyethylene, polypropylene, polyimide, and polybutylene terephthalate.

The battery can 20 according to this aspect may include a crimping part 20C and a beading part 20B. The crimping part 20C is a part of the battery can 20 that wraps around the cap assembly 30 and the gasket 50. Specifically, the battery can 20 and the cap assembly 30 may be crimp-bonded together with the gasket 50 interposed between them, thus forming the crimping part 20C of the battery can 20. More specifically, the gasket 50 is located between the battery can 20 and the cap assembly 30, and then an upper end of the battery can 20 is bent in the direction towards the cap assembly 30, thereby achieving crimp-bonding.

The beading part 20B refers to a portion where a part of the battery can 20 is recessed towards the central axis in a region above the electrode assembly 10, so as to stabilize the position of the cap assembly 30 and prevent the movement of the electrode assembly 10. That is, the cap assembly 30 according to this aspect and the gasket 50 surrounding it become seated on the beading part 20B of the battery can 20 as a result of the above-described crimp bonding.

The gasket 50 according to this aspect is located between the battery can 20 and the cap assembly 30, and thus can enhance the sealing performance of the secondary battery. The gasket 50 may also include an electrically insulating material, and may block the occurrence of a short circuit between the battery can 20 functioning as the second terminal part 112 and the cap assembly 30 functioning as the first terminal part 111. The gasket 50 may include at least one material selected from the group consisting of polypropylene (PP), polyethylene terephthalate (PET), polybutylene terephthalate (PBT), and perfluoroalkoxy alkane (PFA).

The vent part 110V according to this aspect may be formed on the lower surface of the battery cell 110. That is, it may be formed on the bottom part 20F (see FIG. 6) of the battery can 20.

When a thermal event or thermal runaway occurs inside any of the battery cells 110, high-temperature venting gas or particles may be generated. The vent part 110V collectively refers to a member or mechanism that can discharge such high-temperature venting gas or particles. In an aspect, a notch part 110N, which is relatively thinner than a region adjacent to the bottom part of the battery, may may be formed on the lower surface of the battery cell 110. The notch part 110N may have a constant circumference. When the internal pressure of the battery cell 110 increases due to high-temperature venting gas generated inside any one of the battery cells 110, the notch part 110N that is weak in rigidity due to its thin thickness may be ruptured first. Due to the rupture of the notch part 110N, the vent part 110V becomes opened, and high-temperature venting gas or particles, etc. can thereby be discharged through the vent part 110V that is opened.

However, the structure of the vent part 110V is only one illustrative example, and the shape of the vent part 110V is not particularly limited as long as it is a member or mechanism that can discharge the internal venting gas in the event of a thermal event or thermal runaway.

Although not specifically shown in the figures, the battery cell according to the present disclosure may be a prismatic battery cell in which the electrode assembly is stored in a prismatic can. That is, although the battery cell according to this aspect is depicted in the figure as being a cylindrical battery cell, this is only one illustrative structure of the battery cell of the present disclosure, and the battery cell according to other aspects of the present disclosure may be a prismatic battery cell.

The battery cells 110 can be arranged in columns and rows within the cell frame 120, and the battery cells 110 can be electrically connected to each other via busbars or the like, which will be described later.

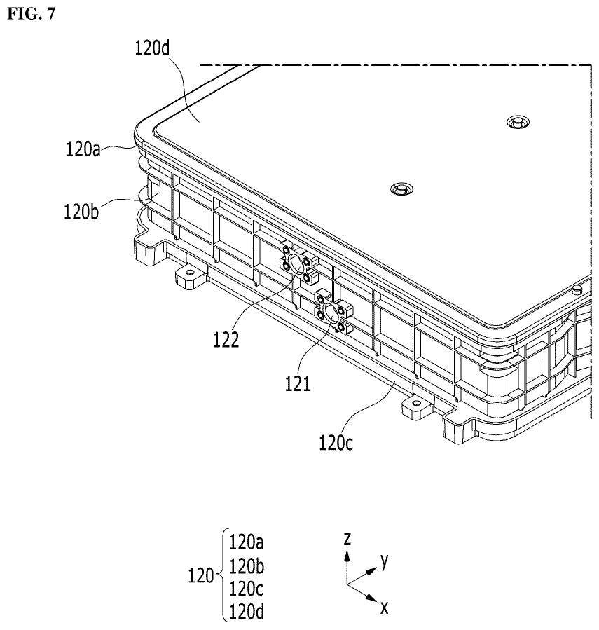

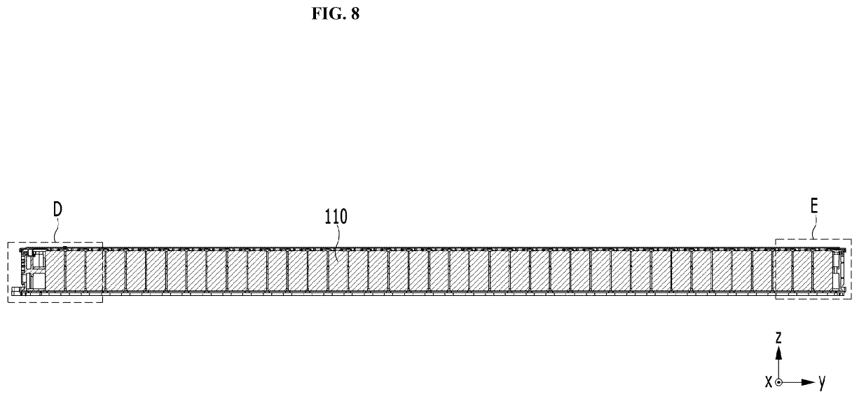

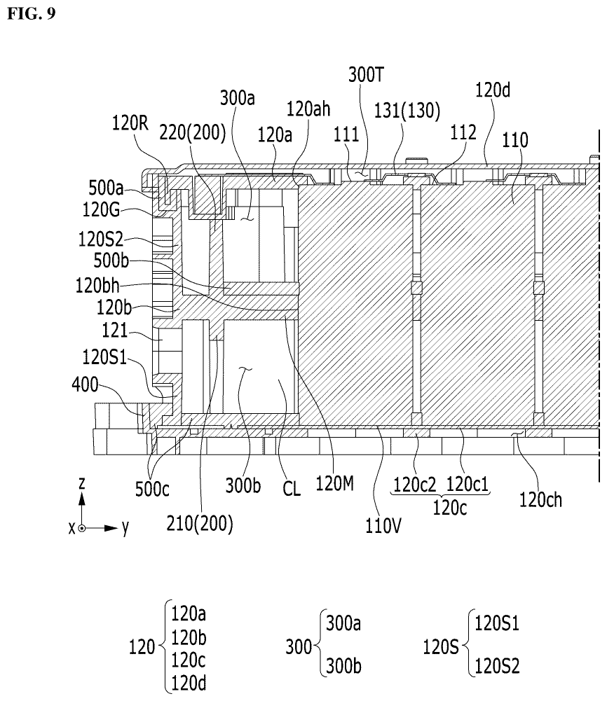

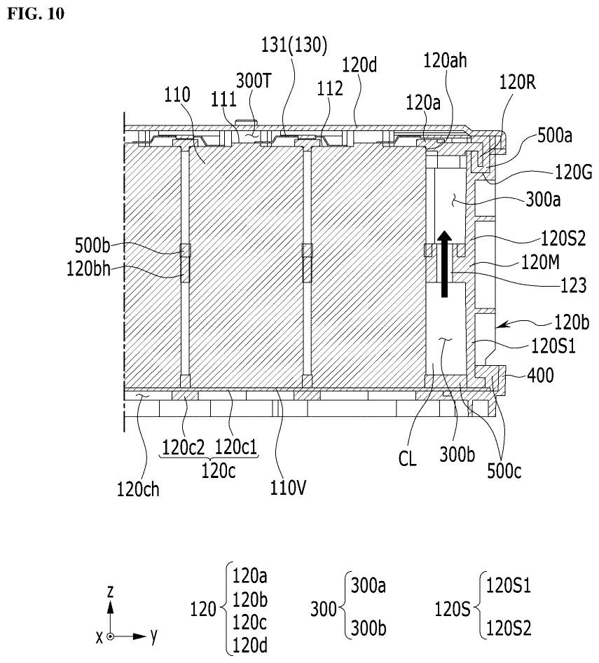

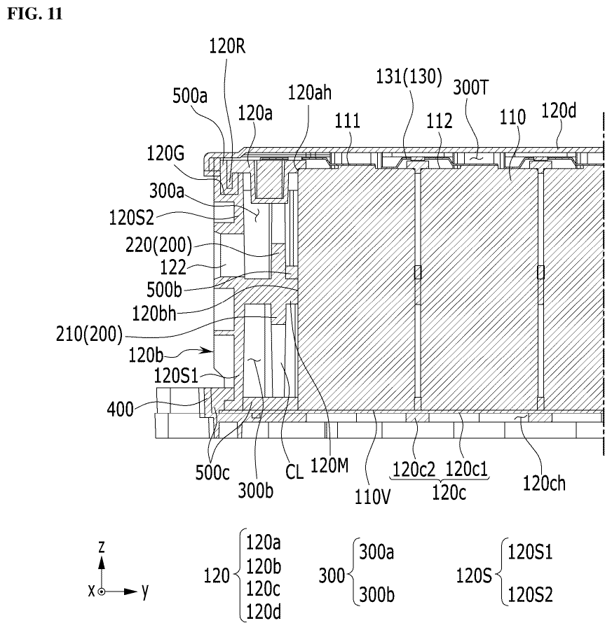

FIG. 7 is a partial perspective view of the battery assembly according to an aspect of the present disclosure. FIG. 8 is a cross-sectional view showing a cross section taken along the cutting line A-A′ of FIG. 2. FIG. 9 is a partially enlarged cross-sectional view showing region “D” of FIG. 8. FIG. 10 is a partially enlarged cross-sectional view showing region “E” of FIG. 8. FIG. 11 is an enlarged cross-sectional view showing a portion of the cross section taken along the cutting line B-B′ of FIG. 2.

Referring to FIGS. 1 to 4 and 7 to 11 together, as described above, the battery assembly 100 includes a cell frame 120 in which battery cells 110 are stored, and the inside of the cell frame 120 may be provided with a cooling flow path 300 through which a coolant CL.

Th coolant CL may circulate through the inside of the cell frame 120 while being in direct contact with at least a part of the battery cells 110. The cell frame 120 may include an inlet port 121 through which the coolant CL flows into the inside of the cell frame 120, and an outlet port 122 through which the coolant is discharged to the outside of the cell frame 120. The coolant CL flowing into the inlet port 121 may flow along the cooling flow paths 300 before being discharged through the outlet port 122. That is, the coolant CL flows into the inside of the cell frame 120 through the inlet port 121, where the coolant CL flowing thereinto comes into direct contact with the battery cells 110 while flowing along the cooling flow path 300 of the cell frame 120, after which the coolant CL may be then discharged to the outside of the cell frame 120 via the outlet port 122.

The battery assembly 100 according to this aspect includes at least one busbar member 131 electrically connected to the terminal parts 111, 112 of the battery cells 110. For example, the battery assembly 100 may include a busbar assembly 130 located at an upper part of the top cell frame 120a, which will be described later. At least one busbar member 131 electrically connected to the terminal parts 111, 112 of the battery cells 110 may be included in the busbar assembly 130. The busbar member 131 according to this aspect may be seated on the top cell frame 120a of the cell frame 120. The busbar member 131 may include a material having electrical conductivity, and for example, it may include a metal material.

As described above, the battery cell 110 may include a first terminal part 111 and a second terminal part 112 as positive and negative electrode terminals. The first terminal part 111 and the second terminal part 112 of the battery cell 110 may be provided in one region of the battery cell 110, such as at one end of the battery cell 110. That is, the first terminal part 111 and the second terminal part 112 may be provided at an upper end of the battery cell 110. However, the positions of the first terminal part 111 and the second terminal part 112 of the battery cell 110 may vary depending on the design, and are not necessarily limited to being positioned at the upper ends of the battery cells 110. Electrical connection between the battery cells 110 may be achieved by a busbar member 131 that connects between the first terminal part 111 and the second terminal part 112. In an aspect, a busbar member 131 can electrically connect the first terminal part 111 of one battery cell 110 to the second terminal part 112 of another battery cell 110. In this way, HV (high voltage) connections may be achieved between battery cells 110. The HV connections are connections that act as a power source for supplying power for which high voltage is required, and refers to electrical connections between battery cells or electrical connections between a battery pack and a device.

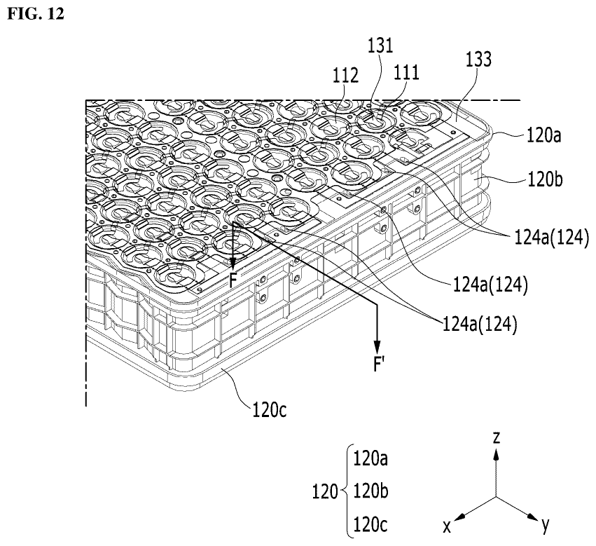

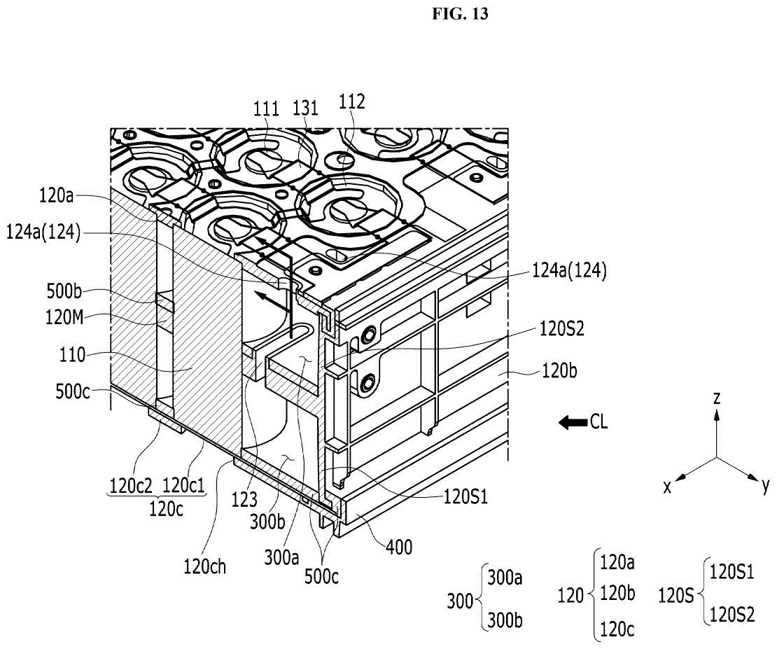

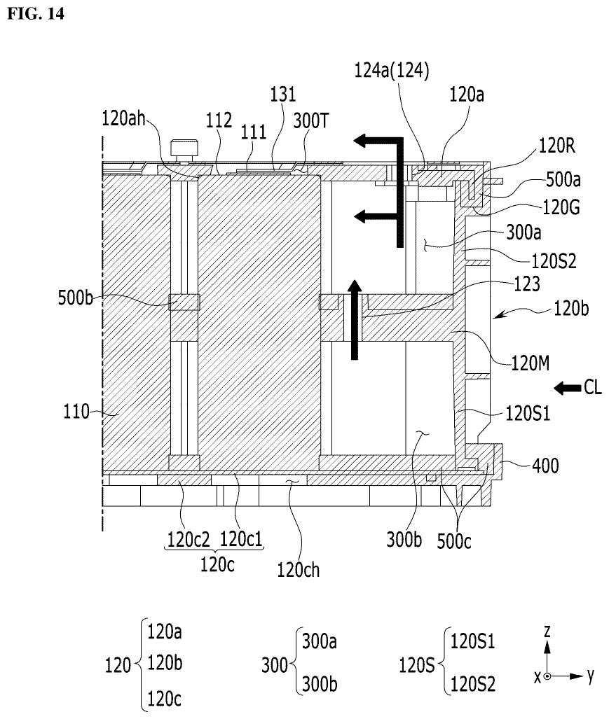

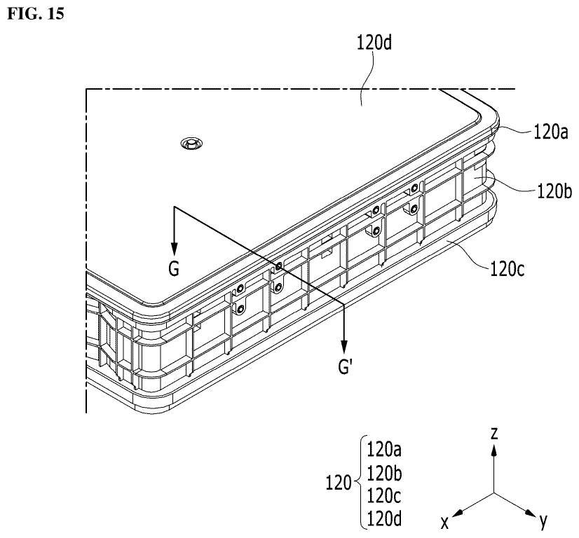

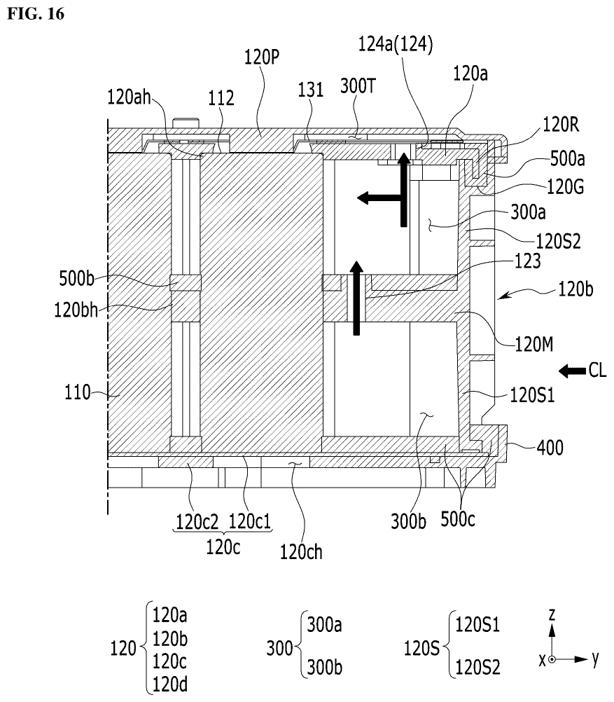

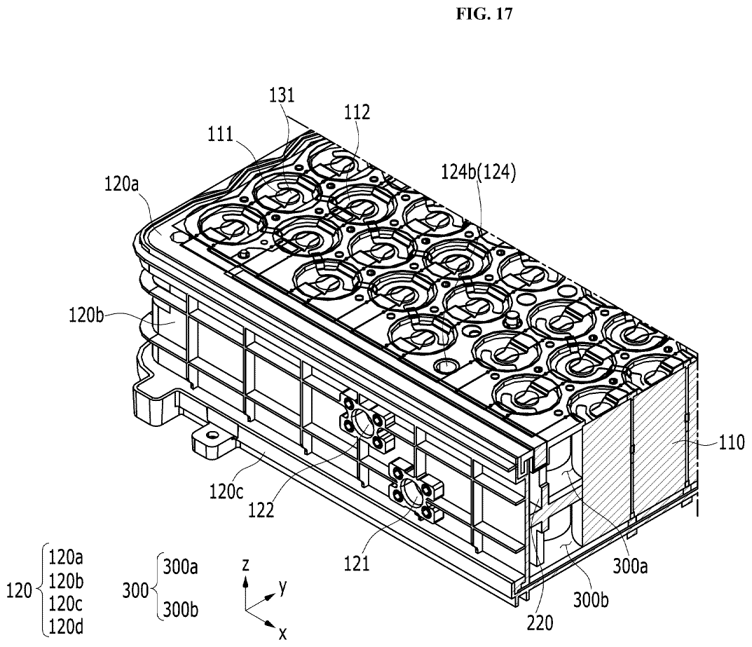

FIG. 12 is a partial perspective view showing a state in which the cell cover is removed from a battery assembly according to an aspect of the present disclosure. FIGS. 13 and 14 are a cross-sectional perspective view and a cross-sectional view, respectively, showing the cross sections taken along the cutting line F-F′ of FIG. 12. FIG. 15 is a partial perspective view showing a state in which the cell cover is included in a battery assembly according to an aspect of the present disclosure. FIG. 16 is a cross-sectional view showing a state taken along the cutting line G-G′ of FIG. 15. FIG. 17 is a cross-sectional perspective view of a portion of a battery assembly according to an aspect of the present disclosure.

Referring to FIGS. 3, 4, and 9 to 17 together, the coolant CL circulates through the inside of the cell frame 120 while being in direct contact with the battery cells 110, and also while being in direct contact with the terminal parts 111, 112 and the busbar members 131 electrically connected to such terminal parts 111, 112, so as to cool them. The terminal parts 111, 112 of the battery cells 110 and the busbar members 131 may thus be cooled by direct contact with the coolant CL.

While charge/discharge of the battery cells 110 is repeated, a great amount of heat is generated in the battery cells 110. Thus, it is important to dissipate this heat by means of a cooling means so as to control the heat in the battery cells 110. If heat dissipation of the battery cells 110 is not properly achieved, the battery cells 110 will deteriorate faster, shortening their lifespan and increasing the possibility of explosion or fire. As described above, the battery assembly 100 according to this aspect employs a system in which a coolant directly cools the battery cells, so that the coolant directly cools the heat generated in the battery cells 110 while being in contact with the battery cells 110.

In the case of a battery cell 110 where charge/discharge is repeated, a great amount of heat is generated particularly intensively in the terminal parts 111, 112, which are parts where the above-mentioned HV connection is performed, as well as in the busbar member 131 connected thereto. In the battery assembly according to this aspect, the coolant CL comes into direct contact with not only the battery cells 110 but also the terminal parts 111, 112 of the battery cells 110 and the busbar member 131 electrically connected to such terminal parts 111, 112, so as to directly cool the terminal parts 111, 112 and the busbar member 131. That is, in the present disclosure, cooling by contact with the coolant CL may be performed on the terminal parts 111, 112, which are the parts of the battery cell 110 where heat generation occurs most greatly, and on the busbar member 131 connected thereto. Since heat generated from the terminal parts 111, 112 and the busbar member 131 may be easily dissipated, the overall cooling performance of the battery assembly 100 can thereby be improved.

The cell frame 120 according to an aspect of the present disclosure may include a top cell frame 120a on which a busbar member 131 is seated, and a cell cover 120d located at an upper part of the top cell frame 120a. Also, the cell frame 120 may include a bottom cell frame 120c on which battery cells 110 are seated, and a middle cell frame 120b that is located on the bottom cell frame 120c and stores the battery cells 110. In this aspect, the top cell frame 120a and the middle cell frame 120b are depicted as separate frames from each other. However, in another aspect of the present disclosure, the top cell frame 120a and the middle cell frame 120b may be integrally formed together as a single component.

A cooling flow path 300 through which the coolant CL flows while being in contact with the battery cells 110 may be provided inside the cell frame 120. For example, the battery cells 110 may be located in an internal space formed by the top cell frame 120a, the middle cell frame 120b, and the bottom cell frame 120c, and the coolant CL may also circulate along the internal space to form the cooling flow path 300.

The top cell frame 120a may cover at least a part of the upper surfaces of the battery cells 110. A busbar member 131 of the busbar assembly 130 may be seated on the top cell frame 120a. The top cell frame 120a may be formed with a top cell frame hole 120ah, and a part of the battery cells 110 may be located in a top cell frame hole 120ah. A part of the battery cells 110 may be exposed to the upper part of the top cell frame 120a through the top cell frame hole 120ah. For example, at least one of the terminal parts 111, 112 of the battery cells 110 may be located in the top cell frame hole 120ah. At least one of the terminal parts 111, 112 of the battery cell 110 may be exposed to the upper part through the top cell frame hole 120ah. FIGS. 9 to 11, 13, 14, and the like show a state in which the whole of the terminal parts 111, 112 of the battery cell 110 is exposed through the top cell frame hole 120ah.

The busbar member 131 seated on the top cell frame 120a may be connected to the terminal parts 111, 112 through the top cell frame holes 120ah. In an aspect, the busbar member 131 may be connected to the terminal parts 111, 112 exposed through the top cell frame holes 120ah by weld-joining.

The cell cover 120d of the cell frame 120 may be located at an upper part of the top cell frame 120a, and also may be located at an upper part of the busbar member 131. The busbar member 131 may be covered by the cell cover 120d.

The coolant CL according to this aspect may flow through a space between the cell cover 120d and the top cell frame 120a. While the coolant CL flows through the space between the cell cover 120d and the top cell frame 120a, it may come into direct contact with the terminal parts 111, 112 of the battery cells 110 and the busbar members 131.

As described above, a cooling flow path 300 through which the coolant CL flows while being in contact with the battery cells 110 may be provided inside the cell frame 120. Further, the present disclosure may be provided with a terminal cooling flow path 300T through which the coolant CL flows in the space between the cell cover 120d and the top cell frame 120a. The coolant CL may flow not only through the cooling flow path 300 but also through the terminal cooling flow path 300T which is the space between the cell cover 120d and the top cell frame 120a, and come into direct contact with the terminal parts 111, 112 and the busbar member 131, thereby cooling them.

For example, the cooling flow path 300 and the terminal cooling flow path 300T may be connected to each other. A part of the coolant CL flowing along the cooling flow path 300 may flow into the space between the cell cover 120d and the top cell frame 120a to form a terminal cooling flow path 300T. A terminal cooling hole 124 for connecting the cooling flow path 300 and the terminal cooling flow path 300T may be formed in the top cell frame 120a.

The coolant CL flows into the cell frame 120 through the inlet port 121, and the coolant CL flowing thereinto flows along the cooling flow path 300 of the cell frame 120 and comes into direct contact with the battery cells 110. A part of the coolant CL flowing along the cooling flow path 300 may flow into a space between the cell cover 120d and the top cell frame 120a through the terminal cooling hole 124 formed in the top cell frame 120a, and then flow along the terminal cooling flow path 300T.

In this aspect, the terminal cooling flow path 300T, which cools the terminal parts 111, 112 and the busbar members 131, is not completely separated from the cooling flow path 300, but a part of the coolant CL flowing in through the inlet port 121 may flow along the cooling flow path 300 and another part may flow along the terminal cooling flow path 300T.

In order to allow separate coolants to flow through the terminal cooling flow path 300T and the cooling flow path 300 while they are separated, a coolant circulation system such as a cooling pump and pipe would need to be provided for each of the terminal cooling flow path 300T and the cooling flow path 300, which would require many components and space. This may reduce the efficiency of space utilization. On the other hand, in the battery assembly 100 according to this aspect, the cooling flow path 300 and the terminal cooling flow path 300T are connected to each other, whereby only one cooling system for circulating the coolant CL, such as a cooling pump and a pipe, may be provided. That is, even by means of one coolant circulation system, the coolant CL may circulate through both the cooling flow path 300 and the terminal cooling flow path 300T. Consequently, the required parts and space can be reduced, so that the weight of the battery assembly 100 and the battery pack including the same can be reduced, and space utilization can be improved.

For example, the coolant CL flowing in through the inlet port 121 flows along the cooling flow path 300 of the cell frame 120 and comes into direct contact with the battery cells 110. As shown in FIGS. 13, 14 and 16, a part of the coolant CL flowing along the cooling flow path 300 may flow into the space between the cell cover 120d and the top cell frame 120a through the first terminal cooling hole 124a formed in the top cell frame 120a. This coolant CL may flow along the terminal cooling flow path 300T, which is the space between the cell cover 120d and the top cell frame 120a, and then may rejoin the cooling flow path 300 via the second terminal cooling hole 124b, which is another terminal cooling hole 124 formed in the top cell frame 120a, as shown in FIG. 17. The coolant CL rejoining the cooling flow path 300 through the second terminal cooling hole 124b may then be discharged to the outside of the battery assembly 100 through the outlet port 122.

The inlet port 121 and the outlet port 122 may be located on the same side (end) of the cell frame 120 as each other, or they may be located on opposite sides to one another. That is, the positions of the inlet port 121 and outlet port 122 in the cell frame 120 are not particularly limited. The inlet port 121 and outlet port 122 may be located in the middle cell frame 120b of the cell frame 120.

The cooling flow path 300 according to this aspect may have a multi-layer cooling structure, and the multi-layer cooling structure will be described below.

Referring again to FIGS. 1 to 3 and 9 to 11, the cooling flow path 300 may include a plurality of cooling flow paths 300a, 300b that are arranged along the longitudinal dimension of the battery cell 110 along which the battery cell 110 extends. The cell frame 120 may include at least one separating part 120M integrally connected to the side surface part 120S of the cell frame 120. Any one of the plurality of cooling flow paths 300 may be located on one side of the separating part 120M, and the other one of the plurality of cooling flow paths 300 may be located on the other side of the separating part 120M.

At least a part of the plurality of cooling flow paths 300 may be divided by at least one separating part 120M. Within the cell frame 120, the cooling flow path 300 may be divided into a plurality of cooling flow paths 300a, 300b by a separating part 120M. For example, FIGS. 9 to 11 illustrate that two cooling flow paths 300a, 300b are divided and separated by the separating part 120M.

In the battery assembly 100 according to this aspect, the separating part 120M for dividing the plurality of cooling flow paths 300 may be formed integrally with the side surface part 120S of the cell frame 120. For example, the cell frame 120 may be manufactured by injection molding under the state where the separating part 120M and the side surface part 120S are integrally connected. Because the separating part 120M is formed integrally with the side surface part 120S, there is low risk of coolant CL leakage between one cooling flow path 300a located on one side of the separating part 120M and another cooling flow path 300b located on the other side of the separating part 120M, as integrating the separating part 120M and the side surface part 120S eliminates a gap between them through which the coolant CL could otherwise leak out. This beneficially reduces the portions of the battery assembly 100 where sealing is required. Therefore, since no additional parts for sealing are required, the number of parts can be reduced, and at the same time, with low risk of leakage of the coolant CL, the sealing performance of the battery assembly can be improved.

The flowing direction of the coolant CL in any one of the plurality of cooling flow paths 300a, 300b may be opposite to the flowing direction of the coolant CL in the other one of the plurality of cooling flow paths 300a, 300b. Further, the directions in which the coolant CL flows in the plurality of cooling flow paths 300a, 300b may be perpendicular to the longitudinal dimensions of the battery cells 110.

The longitudinal dimensions of the battery cells 110 refers to the dimension (of the three orthogonal dimensions oriented with the battery cell 110) along which the battery cell 110 extends the longest. In an aspect, as shown in FIGS. 9 to 11, the battery cell 110 extends longer along the z-axis dimension than along the y-axis dimension, such that the longitudinal dimension of the battery cell 110 would correspond to a dimension parallel to the z-axis dimension. The longitudinal dimension of the battery cell 110 according to this aspect may be a dimension extending between one end of the battery cell 110 and the other opposing end of the battery cell 110 along the central axis defining the radius of the cylindrical-shaped battery can 20. At least one of the terminal parts 111, 112 of the battery cell 110 may be located at the one end of the battery cell 110. For example, as shown in FIGS. 9 to 11, the opposite ends of the battery cell 110 may be the upper surface of the battery cell 110 and the lower surface of the battery cell 110, respectively. At least one of the terminal parts 111, 112 of the battery cell 110 may be located on the upper surface of the battery cell 110. FIGS. 9 to 11 show that the whole of the terminal parts 111, 112 of the battery cell 110 are located along the upper surface of the battery cell 110. As shown in FIGS. 9 to 11, the longitudinal dimension of the battery cell 110 may be a dimension between the upper surface of the battery cell 110 and the lower surface of the battery cell 110, and the longitudinal dimension of the battery cell 110 may be a direction parallel to the z-axis dimension.

A plurality of cooling flow paths 300a, 300b may be disposed along the longitudinal direction, which is the width direction of the portion that extends relatively long in the battery cell 110. In an aspect, the plurality of cooling flow paths 300a, 300b may include a first cooling flow path 300a and a second cooling flow path 300b. The first cooling flow path 300a and the second cooling flow path 300b may be spaced apart from one another along the z-axis dimension, which corresponds to the longitudinal dimension of the battery cell 110. The first cooling flow path 300a may be located higher than the second cooling flow path 300b along the z-axis dimension, and the second cooling flow path 300b may be located lower than the first cooling flow path 300a on the basis of the z-axis dimension. The first cooling flow path 300a may be located above the separating part 120M, and the second cooling flow path 300b may be located below the separating part 120M.

According to this aspect, the cooling flow path 300 through which the coolant CL flows inside the cell frame 120 may have a multi-layer cooling structure. Specifically, the first cooling flow path 300a and the second cooling flow path 300b may be sequentially located along the longitudinal dimensions of the battery cells 110. That is, the multi-layer cooling structure of the cooling flow path 300 mentioned herein means that layered cooling flow paths are divided from each other along the longitudinal dimensions of the battery cells 110. Moreover, the divisions between the layers of the cooling flow paths may be positioned at any point along the longitudinal dimensions of the battery cells 110, such that a portion of the battery cell 110 below that point may be contacted by the second cooling flow path 300b, and a portion of the battery cell 110 above that point may be contacted by the first cooling flow path 300a.

As described above, the flowing direction of the coolant CL in any one of the plurality of cooling flow paths 300a, 300b may be opposite to the flowing direction of the coolant CL in the other one of the plurality of cooling flow paths 300a, 300b. That is, the flowing direction of the coolant CL in the first cooling flow path 300a may be opposite to the flowing direction of the coolant CL in the second cooling flow path 300b.

One of the plurality of cooling flow paths 300a, 300b may be connected to the inlet port 121, and the other one of the plurality of cooling flow paths 300a, 300b may be connected to the outlet port 122. For example, the second cooling flow path 300b may be connected to the inlet port 121, and the first cooling flow path 300a may be connected to the outlet port 122. Further, as shown in FIG. 10, the cell frame 120 may include a connecting hole 123 that connects a plurality of cooling flow paths 300a, 300b. The connecting hole 123 may be formed in the separating part 120M of the cell frame 120.

The connecting hole 123 according to an aspect may connect the first cooling flow path 300a and the second cooling flow path 300b. The coolant CL may flow in through the inlet port 121 and then flow along the second cooling flow path 300b. The coolant CL flowing along the second cooling flow path 300b may then flow into the first cooling flow path 300a through the connecting hole 123. The coolant CL flowing along the first cooling flow path 300a can then be discharged to the outside of the cell frame 120 through the outlet port 122.

It is preferable that the first cooling flow path 300a and the second cooling flow path 300b are not connected to each other until the coolant CL reaches the connecting hole 123. That is, the first cooling flow path 300a and the second cooling flow path 300b may be connected to each other only through the connecting hole 123. The direction in which the coolant CL flows in the first cooling flow path 300a and the direction in which the coolant CL flows in the second cooling flow path 300b may be opposite each other. For example, the coolant CL may flow along the +y-axis direction in the second cooling flow path 300b connected to the inlet port 121, and the coolant CL may flow along the −y-axis direction in the first cooling flow path 300a connected to the outlet port 122.

In the drawings, the cooling flow path 300 is depicted as having a two-layer cooling structure including a first cooling flow path 300a and a second cooling flow path 300b, but the number of the cooling flow paths is not particularly limited, and a cooling structure of three or more layers is also possible. That is, the cooling flow path according to other aspects of the present disclosure may further include a third cooling flow path spaced apart the first and second cooling flow paths along the longitudinal dimensions of the battery cells 110. In addition, the cooling flow path may include a fourth cooling flow path as necessary.

Next, some reasons why the cooling flow path 300 according to this aspect has a multi-layer cooling structure will be described.

If the cooling flow path were formed in a single layer and the coolant CL flows in only one direction, this may cause differences in the order in which the coolant CL comes into contact with a plurality of battery cells 110, which may result in cooling imbalances for each battery cell 110. As a comparative example of the present disclosure, a single-layer cooling flow path in which the coolant CL flows in only one direction may be considered. In this comparative example, the battery cell adjacent to the inlet port is in direct contact with the coolant CL at the temperature that the coolant enters the cell frame 120, so that heat dissipation is performed excellently, but the battery cell adjacent to the outlet port is in contact with the coolant CL that has already been heated by the battery cells with which it has already come into contact, so that heat dissipation is not performed as well. Therefore, a cooling imbalance occurs for each battery cell 110, which may lead to a decrease in the performance of the entire battery assembly.

On the other hand, this aspect having a cooling flow path 300 with a multi-layer cooling structure can greatly reduce the cooling deviation between the battery cells 110. This multi-layer cooling structure thus causes a time difference between the portions of each battery cell 110 that are in contact with the coolant CL. Referring again to FIGS. 9 to 11, in the case of the battery cell 110 closest to the inlet port 121 and the outlet port 122 (the battery cell located on the leftmost side in FIGS. 9 to 11), the portion of the battery cell 110 located in the second cooling flow path 300b is in contact with the coolant CL firstly, and the portion of the battery cell 110 located in the first cooling flow path 300a is in contact with the coolant CL lastly. That is, in the case of the battery cell 110 closest to the inlet port 121 and the outlet port 122, a portion of the battery cell 110 may be in contact with the coolant CL in the coldest state, and other portions of the battery cell 110 may be in contact with the coolant CL in the hottest state. On the other hand, in the case of the battery cell 110 located farthest from the inlet port 121 and outlet port 122 and located closest to the connecting hole 123 (the battery cell located on the rightmost side in FIG. 10), the portion of the battery cell 110 located in the second cooling flow path 300b is in contact with the coolant CL at an intermediate location, and that coolant CL immediately passes through the connecting hole 123 and is in contact with the portion of the battery cell 110 located in the first cooling flow path 300a. That is, in the case of the battery cell 110 located closest to the connecting hole 123, all portions of the battery cell 110 are in contact with the coolant CL at an intermediate temperature.

When viewed based on one battery cell 110, thermal equilibrium through heat transfer may be achieved even between the portion in contact with the first cooling flow path 300a and the portion in contact with the second cooling flow path 300b. As a result, the battery cell 110 closest to the inlet port 121 and the outlet port 122 (the battery cell located on the leftmost side in FIGS. 9 and 11) and the battery cell 110 located furthest from the inlet port 121 and the outlet port 122 and closest to the connecting hole 123 (the battery cell located on the rightmost side in FIG. 10) may be cooled to similar degrees.

By realizing the cooling flow path 300 with a multi-layer cooling structure in this way, it is possible to make a difference in the order of contact with the coolant CL for each portion of multiple battery cells 110. Therefore, it is possible to solve the problem of cooling imbalance between the battery cells 110 and thus minimize the cooling deviation between the battery cells. When the temperature deviation between the battery cells 110 is minimized, it is possible to prevent deterioration of a particular battery cell 110 due to long-term charge/discharge cycles, thereby extending the lifespan of the battery assembly and the battery pack including the same and ensuring safety. Further, other aspects of the present disclosure may have a cooling structure with layers beyond a two layers, such as a three-layer or four-layer cooling structure, which may also help to eliminate the cooling deviations between the battery cells 110 described above.

The separating part 120M is not particularly limited by its shape, thickness, material, etc., as long as it can divide the plurality of cooling flow paths 300a, 300b. In an aspect, FIGS. 9 through 11 show a configuration in which the separating part 120M is included in the middle cell frame 120b.

Based on the positions of the battery cells 110, the inlet port 121 and the outlet port 122 may be located on the same side of the cell frame 120 as one another, and the connecting hole 123 may be located on the opposite side of the location where the inlet port 121 and outlet port 122 are located. However, this is an example structure, and the positions of the inlet port 121, the outlet port 122, and the connecting hole 123 are not particularly limited.

The coolant CL in the present disclosure is a cooling medium that cools a heat-generating object, and its form or material is not limited. Various phases of the coolant CL may be applied. In an aspect, the coolant CL may be a solid, fluid, liquid, or gaseous cooling medium without limitation. Further, bubbles, paraffin, or a phase change material (PCM) may be applied as the coolant CL.

In an aspect, the coolant CL may be a fluid. The coolant CL may be cooling water or cooling oil. Meanwhile, within the battery assembly 100, the coolant CL may be in direct contact with the battery cells 110 and the terminal parts 111, 112, as well as the busbar members 131, and the coolant CL may be electrically insulating. The coolant CL may be a material having electrical insulating properties. In an aspect, the coolant CL may be an insulating oil. However, these are example materials, and as described above, any material capable of cooling an object requiring cooling may be applied as the coolant CL in the present disclosure without limitation.

Meanwhile, the size of the area in contact with the battery cells 110 where the cooling flow path flows in one direction may be 30% or more and 70% or less of the size of the overall area of the battery cells 110 exposed to the coolant CL. For example, the cross sectional area of first cooling flow path 300a perpendicular to the flow direction may be 30% or more and 70% or less than the total cross sectional area of the flow paths in contact with the battery cells (i.e., the sum of the cross sectional areas of both the first and second cooling flow paths 300a, 300b perpendicular to the flow direction). In another example, the size of the area in contact with the battery cells 110 where the cooling flow path flows in one direction may be 40% or more and 60% or less of the size of the overall area of the battery cells 110 exposed to the coolant CL.

If the size of the area in contact with the battery cells 110 where the cooling flow path flows in one direction is less than 30% or more than 70% of the size of the overall area of the battery cells 110 exposed to the coolant CL, the size of the region where a specific cooling flow path 300 is in contact with the battery cells 110 may be excessively large or excessively small. In such a case, the degree of cooling for the battery cells 110 may vary for each zone, which may result in a cooling imbalance between the battery cells 110. Ultimately, this may increase the cooling deviation between the battery cells 110 within the battery assembly 100.

The separating part 120M may be located in the space between the 30% point of the height of the battery cell 110 and the 70% point of the height of the battery cell 110. The height of the battery cell 110 may correspond to the length from the lower end of the battery cell 110 to the upper end of the battery cell 110.

If the separating part 120M is located in a space that is not between the 30% point and the 70% point of the height of the battery cells 110 along the longitudinal dimensions of the battery cells 110, the size of the area in contact with the battery cells 110 where the plurality of cooling flow paths 300a, 300b come into contact with the battery cells 110 may be excessively large or excessively small. In such a case, the degree of cooling for the battery cells 110 may vary for each zone, which may result in a cooling imbalance between the battery cells 110. Ultimately, this may increase the cooling deviation between the battery cells 110 within the battery assembly 100.

In the cooling flow paths 300 having a multi-layer cooling structure, any one of the cooling flow paths 300 may be connected to a terminal cooling flow path 300T. For example, referring to FIGS. 12 to 17, the first cooling flow path 300a of the cooling flow paths 300 may be connected to the terminal cooling flow path 300T. That is, the coolant CL flowing in through the inlet port 121 and then flowing along the second cooling flow path 300b may move to the first cooling flow path 300a through the connecting hole 123. A part of the coolant CL that has moved to the first cooling flow path 300a through the connecting hole 123 may then move to the terminal cooling flow path 300T through the first terminal cooling hole 124a, and the remainder of the coolant CL may move along the first cooling flow path 300a. Subsequently, the coolant CL flowing along the terminal cooling flow path 300T may be joined to the first cooling flow path 300a through the second terminal cooling hole 124b (see FIG. 17) and then discharged through the outlet port 122.

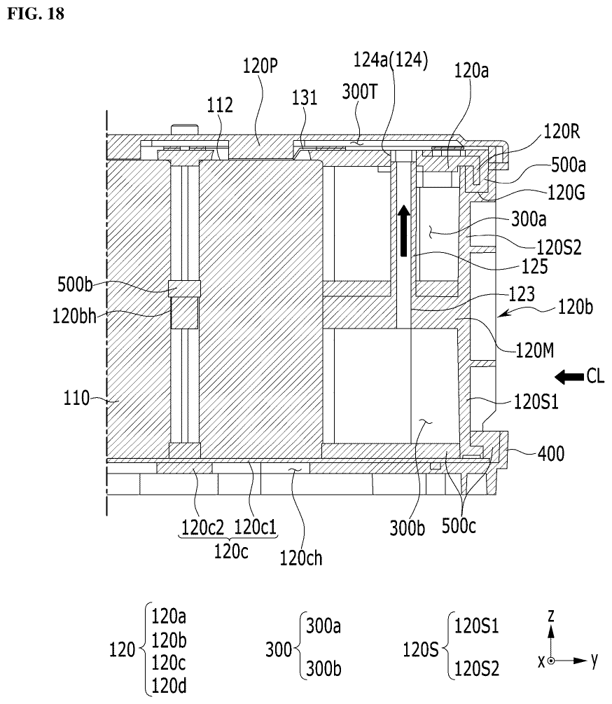

FIG. 18 is a cross-sectional view of a battery assembly according to another aspect of the present disclosure, showing a view similar to that of FIG. 16.

Referring to FIG. 18 together with FIG. 17, in the battery assembly 100 according to the depicted aspect, the second cooling flow path 300b of the cooling flow paths 300 may be connected to the terminal cooling flow path 300T. A connecting pipe 125 for connecting the connecting hole 123 and the first terminal cooling hole 124a may be provided. A plurality of such connecting holes 123 may be provided, and the connecting pipe 125 may be provided for a subset of the plurality of connecting holes 123. A part of the coolant CL flowing in through the inlet port 121 and then flowing along the second cooling flow path 300b may move to the terminal cooling flow path 300T through the subset of the connecting holes 123 having the connecting pipe 125. A part of the remainder of the coolant CL flowing along the second cooling flow path 300b may move to the first cooling flow path 300a through the remaining connecting holes 123. Subsequently, the coolant CL flowing along the terminal cooling flow path 300T may be joined to the first cooling flow path 300a through the second terminal cooling hole 124b (see FIG. 17) and then discharged through the outlet port 122.

In an aspect, the terminal cooling flow path 300T may be connected to the first cooling flow path 300a, and in another aspect, it may be connected to the second cooling flow path 300b. The terminal cooling flow path 300T may be selectively connected to any one of the plurality of cooling flow paths 300. Furthermore, although not specifically shown in the figures, in one battery assembly 100, the terminal cooling flow path 300T may be connected to both the first cooling flow path 300a and the second cooling flow path 300b. In such an aspect, a plurality of the first terminal cooling holes 124a may be provided, wherein a subset of the first terminal cooling holes 124a may be connected to the first cooling flow path 300a, as shown in FIGS. 14 and 16, and the remaining ones of the first terminal cooling holes 124a may be connected to the second cooling flow path 300b through a connecting pipe 125, as shown in FIG. 18. The connection configuration of the plurality of first terminal cooling holes 124a may be variously set, so that a configuration in which the terminal cooling flow path 300T is connected to both the first cooling flow path 300a and the second cooling flow path 300b can also be realized.

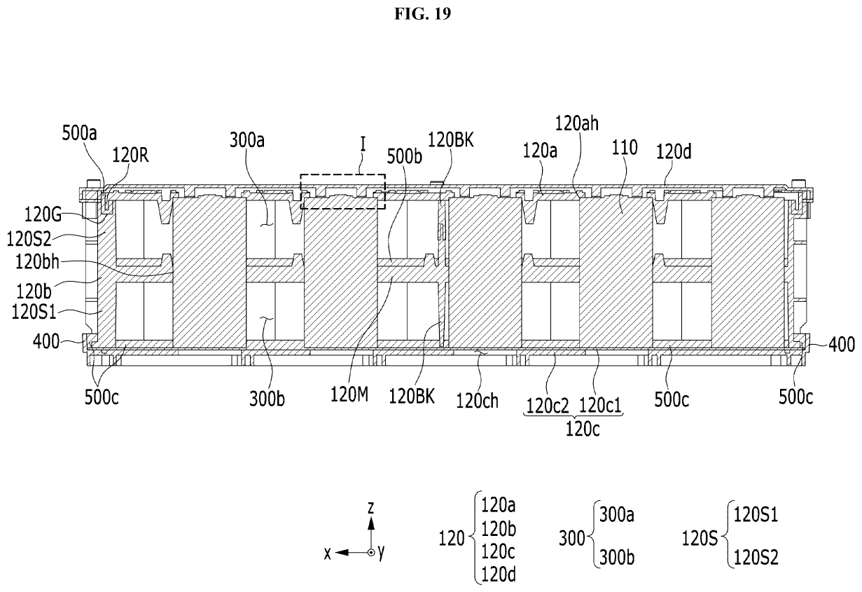

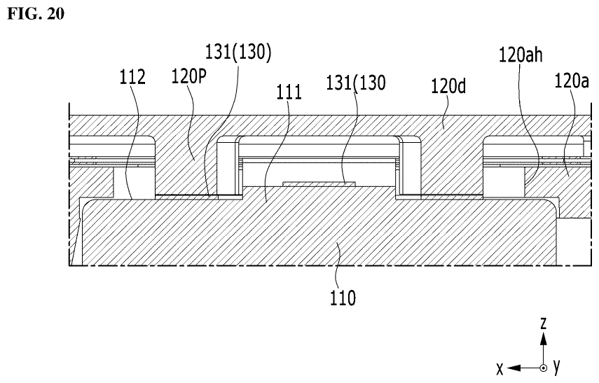

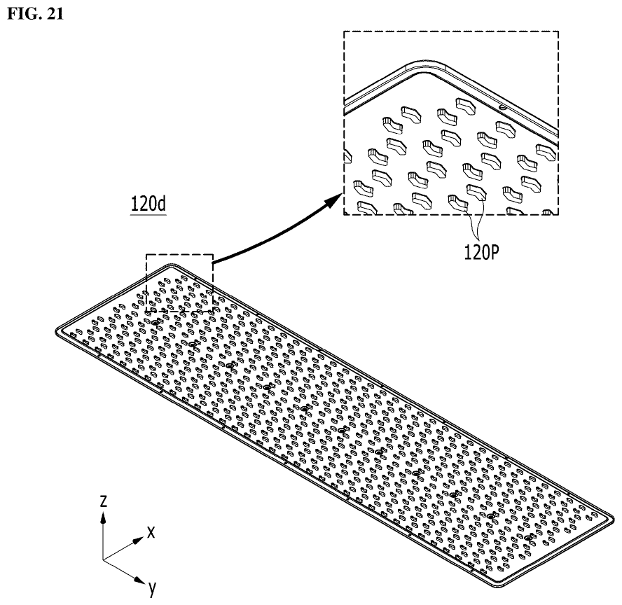

FIG. 19 is a cross-sectional view showing a state taken along the cutting line H-H′ of FIG. 2. FIG. 20 is an enlarged partial view of a section “I” of FIG. 19. FIG. 21 is a perspective view showing a cell cover according to an aspect of the present disclosure. Specifically, FIG. 21 is a perspective view of the cell cover 120d as viewed from below so that the lower surface of the cell cover 120d is visible.

Referring to FIGS. 2, 16, and 19 to 21 together, the cell cover 120d according to this aspect may include protruding parts 120P formed on one surface of the cell cover 120d. In an aspect, the protruding parts 120P may be formed on one surface of the cell cover 120d facing the terminal parts 111, 112 and the busbar members 131. The protruding parts 120P may be formed on the lower surface of the cell cover 120d. The protruding parts 120P may be formed on the lower surface of the cell cover 120d and protruding in the downward direction. The protruding parts 120P may protrude toward the portion where the terminal parts 111, 112 of the battery cells 110 and the busbar members 131 are connected. For example, FIGS. 19 and 20 show a state in which a protruding part 120P protrudes towards the portion where the second terminal part 112 of the battery cell 110 and the busbar member 131 are connected.

The protruding parts 120P according to this aspect can press at least a part of the portion where the terminal parts 111, 112 of the battery cells 110 and the busbar members 131 are connected. The cell cover 120d may be coupled and fixed to at least one of the top cell frame 120a or the middle cell frame 120b. The coupling and fixing method are not particularly limited. In an aspect, the cell cover 120d may be coupled and fixed to at least one of the top cell frame 120a or the middle cell frame 120b through bolt fastening. While the cell cover 120d is coupled and fixed to at least one of the top cell frame 120a or the middle cell frame 120b, the protruding parts 120P may press at least a part of the portion where the terminal parts 111, 112 of the battery cells 110 and the busbar members 131 are connected. Thereby, while the coolant CL flows along the terminal cooling flow path 300T, the portion where the terminal parts 111, 112 of the battery cells 110 and the busbar members 131 are connected may be stably fixed.

The protruding parts 120P according to this aspect are fixed by an adhesive member to at least a part of the portion where the terminal parts 111, 112 of the battery cells 110 and the busbar members 131 are connected. For example, the busbar members 131 may be connected to the terminal parts 111, 112. One surface of the busbar members 131 may be connected in contact with the terminal parts 111, 112. FIG. 20 shows a state in which one surface of the busbar member 131 is connected in contact with the second terminal part 112. An adhesive member may be interposed between the lower surface of the protruding part 120P and the portion of the busbar member 131 connected to the terminal parts 111, 112. Thereby, the protruding part 120P may be adhesively fixed to the busbar member 131. The adhesive material is not limited by the material or shape, as long as it has adhesive properties. In an aspect, the adhesive material may be an adhesive tape or adhesive.

The coolant CL flows along the terminal cooling flow path 300T, and the cell cover 120d may be located along an upper part of this terminal cooling flow path 300T. Due to the pressure required for the coolant CL to move from the inlet port 121 to the outlet port 122, the internal pressure caused by the circulation of the coolant CL can increase to a considerable level. If the cell cover 120d fails to withstand the internal pressure caused by the circulation of the coolant CL and becomes deformed, structural deformation may occur across the entire battery assembly 100, and the coolant CL may easily leak. In this aspect, the protruding part 120P of the cell cover 120d may be fixed by an adhesive member, so that the cell cover 120d can withstand the internal pressure caused by the circulation of the coolant CL and deformation of the cell cover 120d can be prevented. As a result, it is possible to minimize structural deformation of the entire battery assembly 100 and leakage of coolant CL.

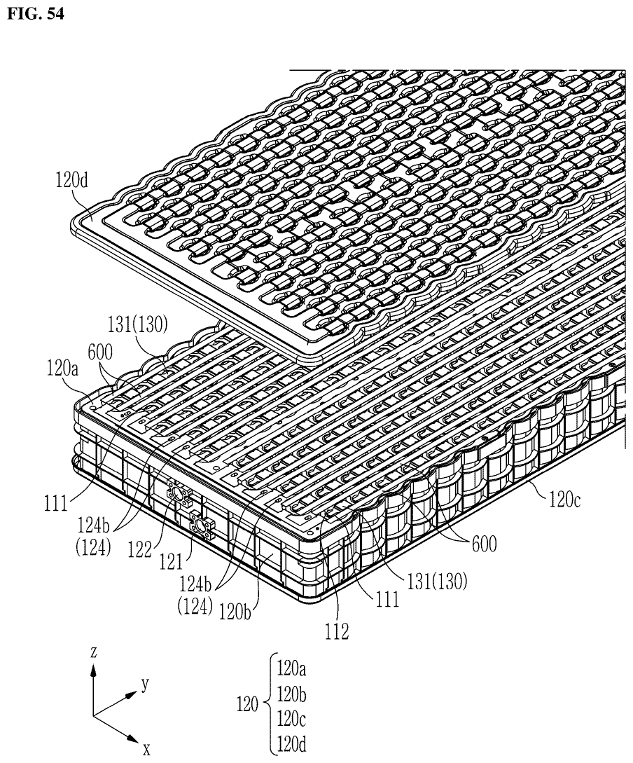

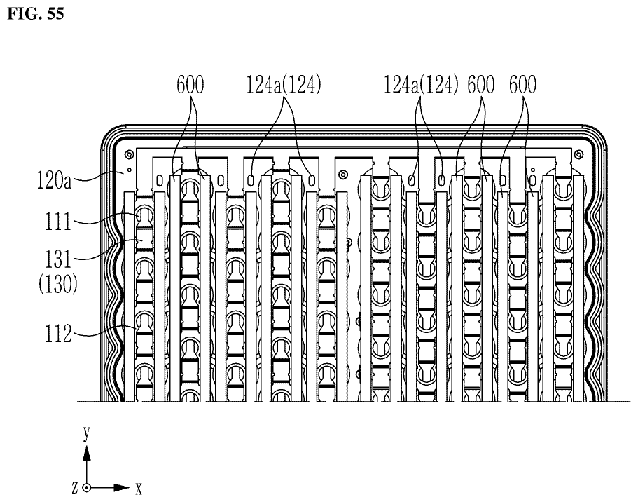

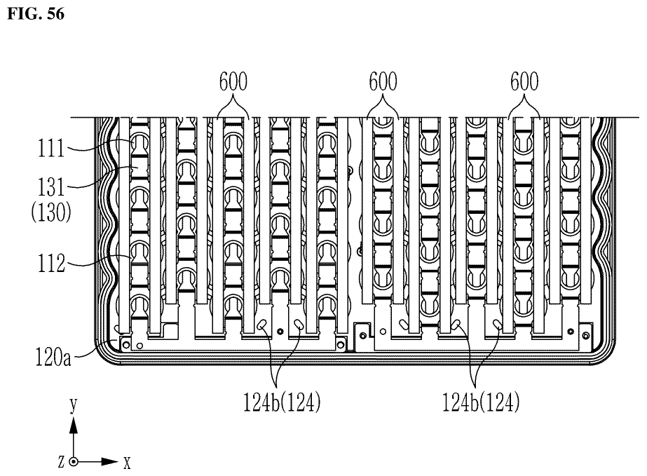

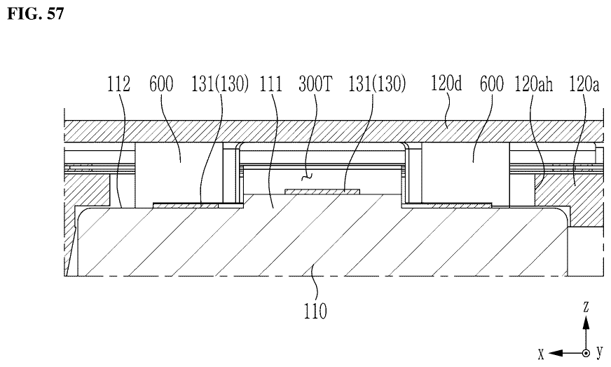

In a related aspect, an adhesive may be used to fix the cell cover 120d to the top cell frame 120a. Whether or not the cell cover 120d includes the protruding parts 120P discussed above, such adhesive can help to secure the cell cover 120d to the top cell frame 120a across the span of those components despite the pressure caused by the coolant CL, as discussed above. Moreover, that adhesive can also be used to define channels to direct the coolant within the terminal cooling flow path 300T that extends in the space between the cell cover 120d and the top cell frame 120a. For example, the adhesive may be applied in generally parallel, linear strips 600 extending along the longitudinal dimension (y-axis) between each row of the battery cells 110 extending along that dimension, as illustrated in FIGS. 54-57. The result would be to define parallel channels, each of which directs coolant CL into contact with the busbar members 131 and terminal parts 111, 112 of the battery cells 110 within that row. That is, as shown in FIGS. 54-56, the adhesive may be applied in multiple parallel, linear strips 600 extending along the longitudinal (y-axis) dimension. Such adhesive may secure the cell cover 120d to the top cell frame 120a as well as to the battery cell 110, as illustrated in FIG. 57. Moreover, between each pair of mutually adjacent linear strips 600, channels are defined in order to guide the flow of the coolant. As shown in FIG. 55, such coolant enters the space between the cell cover 120d and the top cell frame 120a via the first terminal cooling holes 124a spaced apart along the lateral (x-axis) dimension proximate one end of the cell frame 120, and then the coolant proceeds to flow in the −y axis dimension along channels defined between the parallel, linear strips 600 of adhesive, where the coolant comes into direct contact with the busbar members 131 and terminal parts 111, 112. Then, as shown in FIG. 56, the coolant exiting the channels defined between the linear strips 600 of adhesive may be returned to first cooling flow path 300a via the second terminal cooling holes 124b spaced apart along the lateral (x-axis) dimension proximate the opposite end of the cell frame 120 to that illustrated in FIG. 55.

In an example in which the cell cover 120d includes the protruding parts 120P, the adhesive may be applied along the protruding parts 120P and then continue in linear segments connecting the protruding parts 120P along the longitudinal (y-axis) dimension. In a further alternative, the adhesive may be utilized to define different configurations of coolant flow channels, such as meandering or serpentine flow paths of the coolant CL within the terminal cooling flow path 300T.

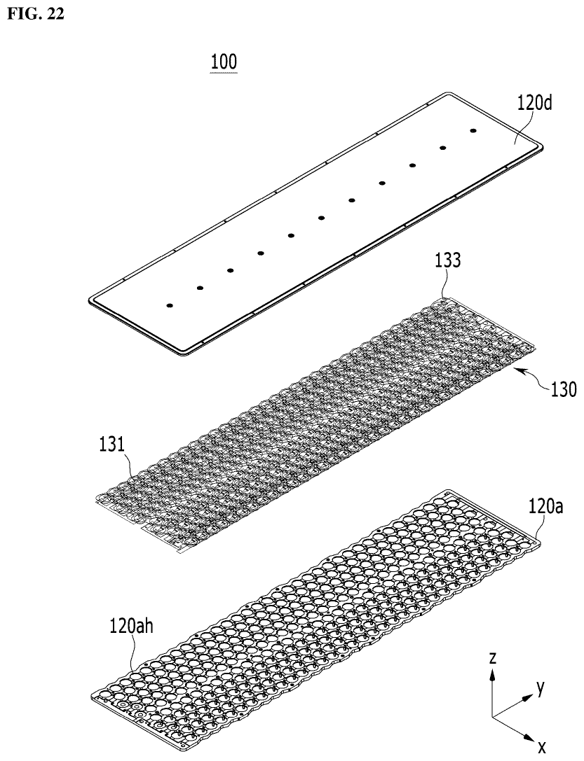

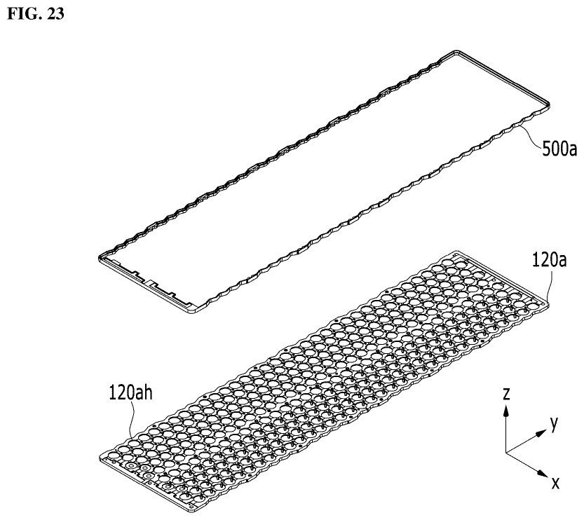

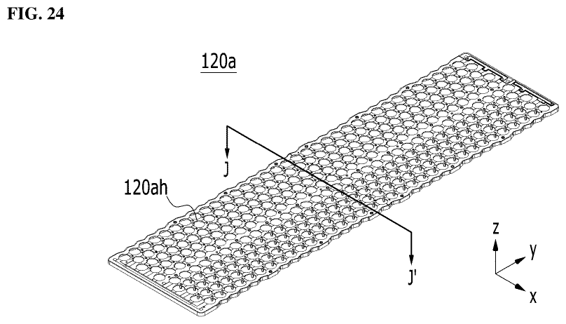

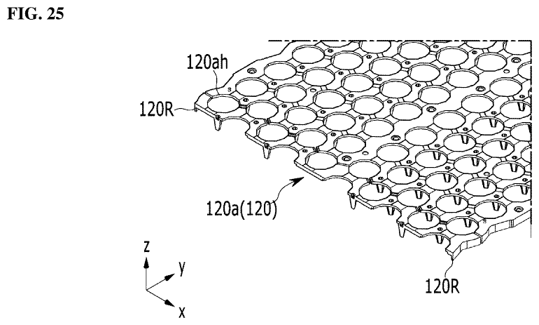

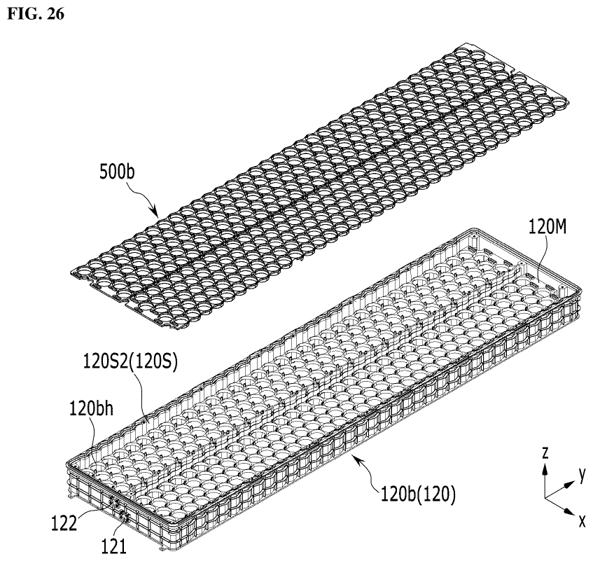

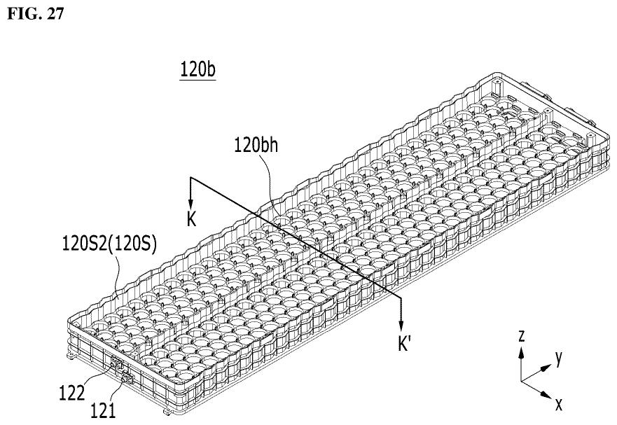

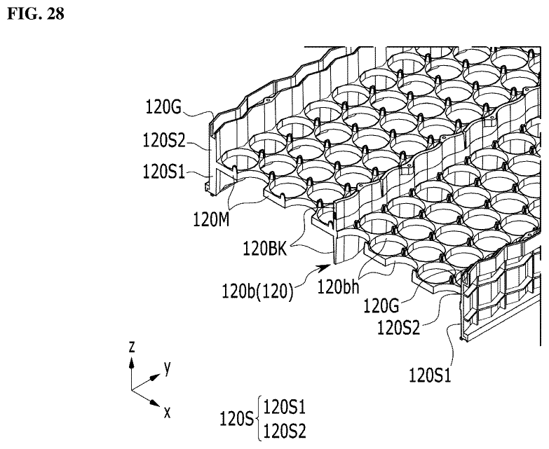

FIG. 22 is an exploded perspective view showing a top cell frame, a busbar assembly, and a cell cover according to an aspect of the present disclosure. FIG. 23 is an exploded perspective view showing a top cell frame and a first sealing member according to an aspect of the present disclosure. FIG. 24 is a perspective view showing a top cell frame according to an aspect of the present disclosure. FIG. 25 is a perspective cross-sectional view showing a cross section taken along the cutting line J-J′ of FIG. 24. FIG. 26 is an exploded perspective view showing a middle cell frame and a second sealing member according to an aspect of the present disclosure. FIG. 27 is a perspective view showing a middle cell frame according to an aspect of the present disclosure. FIG. 28 is a cross-sectional perspective view showing a cross section taken along the cutting line K-K′ of FIG. 27.

Referring to FIGS. 3, 9 to 11, and 22 to 28 together, the cell frame 120 according to this aspect may include a bottom cell frame 120c on which battery cells 110 are seated, a middle cell frame 120b located on the bottom cell frame 120c, a top cell frame 120a located on the middle cell frame 120b, and a cell cover 120d located on the top cell frame 120a.

The space between the middle cell frame 120b and the bottom cell frame 120c and the space between the top cell frame 120a and the middle cell frame 120b may each correspond to cooling flow paths 300. For example, the space between the middle cell frame 120b and the bottom cell frame 120c may be a second cooling flow path 300b, and the space between the top cell frame 120a and the middle cell frame 120b may be a first cooling flow path 300a.

The battery cells 110 according to this aspect may be inserted inside the cell frame 120. For example, a plurality of holes 120h may be formed inside the cell frame 120, and each of the battery cells 110 may be fixed inside the cell frame 120 in positions received within the holes 120h.

In an aspect, the plurality of holes 120h of the cell frame 120 may include a top cell frame hole 120ah and a middle cell frame hole 120bh. The top cell frame hole 120ah may be formed in the top cell frame 120a, and the middle cell frame hole 120bh may be formed in the middle cell frame 120b. In particular, the middle cell frame hole 120bh may be formed in the separating part 120M.

The top cell frame 120a according to an aspect of the present disclosure may be a plate-shaped member. The top cell frame holes 120ah may be formed in the top cell frame 120a. As described above, the terminal parts 111, 112 of the battery cells 110 may be exposed through the top cell frame holes 120ah and electrically connected to the busbar members 131. The top cell frame 120a may cover at least a part of the upper surfaces of the battery cells 110.

According to an aspect of the present disclosure, the separating part 120M and the side surface part 120S in the cell frame 120 may be provided in the middle cell frame 120b. In other words, the middle cell frame 120b may include the separating part 120M and the side surface part 120S.

The side surface part 120S may include a first side surface part 120S1 that extends downward from the edge of the separating part 120M and a second side surface part 120S2 that extends upward from the edge of the separating part 120M. The space surrounded by the first side surface part 120S1, the separating part 120M, and the bottom cell frame 120c may correspond to the second cooling flow path 300b. Also, the space surrounded by the second side surface part 120S2, the separating part 120M and the top cell frame 120a may correspond to the first cooling flow path 300a. The inlet port 121 may be provided in the first side surface part 120S1, and the outlet port 122 may be provided in the second side surface part 120S2.

The first side surface part 120S1 and the second side surface part 120S2 may have an integrated shape. The first side surface part 120S1 and the second side surface part 120S2 may each be integrally connected to the separating part 120M. Because the first side surface part 120S1, the second side surface part 120S2, and the separating part 120M are integrally formed, there is little risk of coolant CL leakage between one cooling flow path 300a located on one side of the separating part 120M and another cooling flow path 300b located on the other side of the separating part 120M. There is low risk that the coolant CL of the first cooling flow path 300a leaks between the second side surface part 120S2 and the separating part 120M, and there is low risk that the coolant CL of the second cooling flow path 300b leaks between the first side surface part 120S1 and the separating part 120M. This is because the first side surface part 120S1, the second side surface part 120S2, and the separating part 120M are integrated, and thus a gap between them through which the coolant CL could otherwise leak out is eliminated. Therefore, since no additional parts for sealing are required, the number of parts can be reduced, and at the same time, with risk of leakage of the coolant CL, the sealing performance of the battery assembly can be improved.

The middle cell frame 120b may include middle cell frame holes 120bh into which battery cells 110 are inserted. The battery cells 110 may be mounted and fixed to the middle cell frame 120b while being inserted into the middle cell frame holes 120bh. While the battery cells 110 is inserted into the middle cell frame holes 120bh, a portion of each battery cell 110 may be in contact with the second cooling flow path 300b, and another portion of each battery cell 110 may be in contact with the first cooling flow path 300a.

The cell cover 120d may be a plate-shaped member and, as described above, may be coupled and fixed to at least one of the top cell frame 120a or the middle cell frame 120b. The cell cover 120d covers the upper part of the terminal cooling flow path 300T and prevents the coolant CL flowing along the terminal cooling flow path 300T from leaking upward.

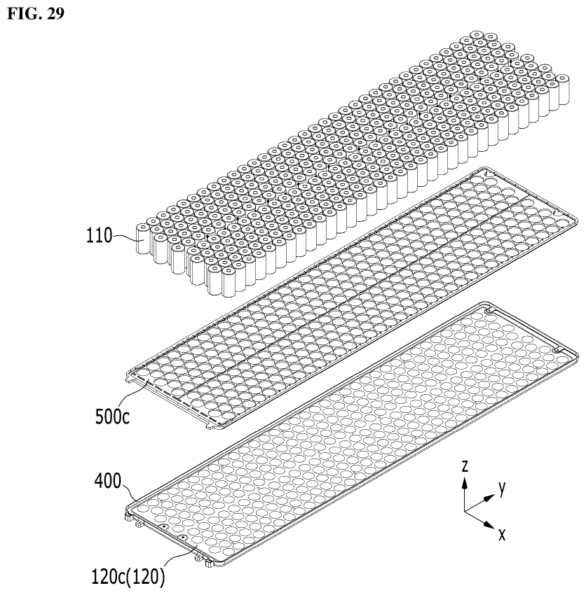

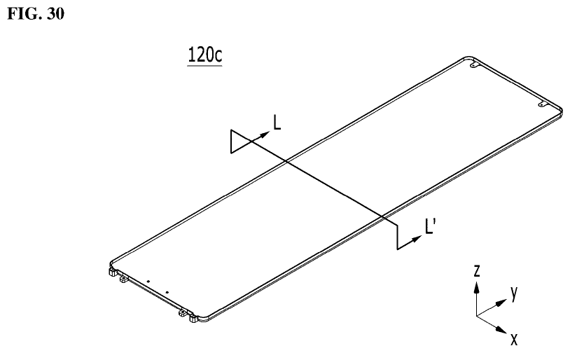

FIG. 29 is an exploded perspective view showing battery cells, a third sealing member, and a bottom cell frame according to an aspect of the present disclosure. FIG. 30 is a perspective view showing a bottom cell frame according to an aspect of the present disclosure.

Referring to FIGS. 3, 9 to 11, 29 and 30 together, the battery cells 110 may be seated on a bottom cell frame 120c. The bottom cell frame 120c according to an aspect of the present disclosure may be a plate-shaped member. Since the middle cell frame 120b includes a first side surface part 120S1 and a second side surface part 120S2, a plurality of cooling flow paths 300a, 300b may be realized even by means of the plate-shaped bottom cell frame 120c and the plate-shaped top cell frame 120a.

Referring again to FIGS. 9 to 11, 23, 26 and 29, the battery assembly 100 according to an aspect of the present disclosure may include sealing members 500a, 500b, 500c for preventing the coolant CL from leaking from the cell frame 120. Because the battery assembly 100 according to this aspect employs a direct cooling method using the coolant CL, a stable sealing structure is essentially required to prevent the coolant CL from leaking to the outside. If the coolant CL leaks outside the cell frame 120 of the battery assembly 100, the amount of coolant CL inside the cell frame 120 may become insufficient, and the coolant CL may not circulate properly, which can reduce cooling performance. Further, the leaked coolant CL may adversely affect other electrical components other than the battery assembly 100. Sealing members 500a, 500b, and 500c may be provided to prevent a coolant CL from leaking inside or outside the cell frame 120.

In an aspect, at least a part of the sealing member 500a may cover the portion between the side surface part 120S and the top cell frame 120a. The sealing member covering the portion between the side surface part 120S and the top cell frame 120a is referred to as the first sealing member 500a.

At least a part of the first sealing member 500a may cover the portion between the middle cell frame 120b and the top cell frame 120a. The first sealing member 500a may prevent the coolant CL from leaking between the side surface part 120S of the middle cell frame 120b and the top cell frame 120a. For example, the first sealing member 500a may cover the portion between the second side surface part 120S2 and the top cell frame 120a, and may prevent the coolant CL from leaking between the second side surface part 120S2 and the top cell frame 120a.

At least a part of the first sealing member 500a may cover the position between the top cell frame 120a and the cell cover 120d. The first sealing member 500a may prevent the coolant CL from leaking to the outside of the terminal cooling flow path 300T between the top cell frame 120a and the cell cover 120d. In the battery assembly 100, the sealing structure at the upper end may be realized by means of the first sealing member 500a.

According to this aspect, at least a part of the sealing member 500c may cover the portion between the middle cell frame 120b and the bottom cell frame 120c. At least a part of the sealing member 500c may cover the portion between the side surface part 120S of the middle cell frame 120b and the bottom cell frame 120c. The sealing member covering the portion between the side surface part 120S and the bottom cell frame 120c is referred to as the third sealing member 500c. At least a part of the third sealing member 500c may cover the portion between the first side surface part 120S1 and the bottom cell frame 120c, and may prevent the coolant CL from leaking between the first side surface part 120S1 and the bottom cell frame 120c.

At least a part of the third sealing member 500c may be located on the bottom cell frame 120c. As will be described later, the third seal member 500c may have an adhesive component. The third sealing member 500c not only may prevent leakage of the coolant CL between the side surface part 120S and the bottom cell frame 120c, but also may stably fix the battery cells 110 on the bottom cell frame 120c.

The cell frame 120 according to this aspect may include a basket 400 that provides a space where a part of the third sealing member 500c is located. For example, the basket 400 may be provided on the bottom cell frame 120c, as shown in FIGS. 9 to 11.

The basket 400 may be a portion of the bottom cell frame 120c that covers a part of the outer side surface of the middle cell frame 120b. The basket 400 may be formed on the outer circumference of the region where the battery cells 110 are seated within the bottom cell frame 120c. A third sealing member 500c may be located in the basket 400. Specifically, when viewed along a direction perpendicular to one surface of the bottom cell frame 120c, the basket 400 may be formed on the outer circumference of the region where the battery cells 110 are seated. Here, viewed along a direction perpendicular to one surface of the bottom cell frame 120c means viewing the bottom cell frame 120c along the +z-axis direction or the −z-axis direction towards the xy-plane.

By forming the basket 400 on the outer circumference of the region where the battery cells 110 are seated within the bottom cell frame 120c, a space in which the third sealing member 500c can be located is provided. By disposing a part of the third sealing member 500c in the basket 400, the length of the sealing interface is extended, thereby preventing the coolant CL from leaking through the gap between the bottom cell frame 120c and the middle cell frame 120b.

The basket 400 can extend along the outer circumference of the region where the battery cells 110 are seated within the bottom cell frame 120c. Further, a part of the third sealing member 500c can also extend along the outer circumference of the region where the battery cells 110 are seated within the bottom cell frame 120c.

In an aspect of the present disclosure, the basket 400 may extend uninterrupted along the outer circumference of the region where the battery cells 110 are seated within the bottom cell frame 120c. A part of the third sealing member 500c may also extend uninterrupted along the outer circumference of the region where the battery cells 110 are seated within the bottom cell frame 120c. That is, the basket 400 and the third sealing member 500c may surround the outer circumference of the region where the battery cells 110 are seated.

As previously described, since the separating part 120M is integrally connected to the side surface part 120S, a gap through which the coolant CL can leak out will not be present between the separating part 120M and the side surface part 120S. Therefore, a sealing member for preventing leakage of the coolant CL may not be required between the separating part 120M and the side surface part 120S. On the other hand, there is a risk of coolant CL leakage in the gap between the side surface part 120S and the top cell frame 120a and the gap between the side surface part 120S and the bottom cell frame 120c. Thus, in an aspect of the present disclosure, a part of the first sealing member 500a may cover the portion between the side surface part 120S and the top cell frame 120a and the portion between the top cell frame 120a and the cell cover 120d, and a part of the third sealing member 500c may cover the portion between the side surface part 120S and the bottom cell frame 120c.

The battery assembly 100 according to this aspect may include a second sealing member 500b located on the separating part 120M. The sealing member located on the separating part 120M is referred to as the second sealing member 500b. As described above, in the cooling flow path 300 having the multi-layer cooling structure, it is preferable that the first cooling flow path 300a and the second cooling flow path 300b are not connected to each other until the coolant CL reaches the connecting hole 123. That is, the first cooling flow path 300a and the second cooling flow path 300b may be connected to each other only through the connecting hole 123. This is because, as discussed above, it results in a flow path 300 that contacts a portion of each of the plurality of battery cells 110 before returning and contacting a different portion of each of the battery cells, thereby reducing cooling deviation of the battery cells. The second sealing member 500b may prevent the coolant CL of the first cooling flow path 300a from moving to the second cooling flow path 300b, or the coolant CL of the second cooling flow path 300b from moving to the first cooling flow path 300a, at portions other than the connecting hole 123. A waterproof airtight structure between the first cooling flow path 300a and the second cooling flow path 300b excluding the connecting hole 123 may be achieved by the second waterproof adhesive 500b. The gap between the middle cell frame hole 120bh and the battery cell 110 inserted therein can be filled with the second waterproof adhesive 500b. The second sealing member 500b is not configured to prevent the coolant CL from leaking to the outside of the cell frame 120, but may be configured to prevent the coolant CL from moving beyond the separating part 120M.

The sealing members 500a, 500b, 500c of the present disclosure are not particularly limited by the shape or material, as long as they can prevent the coolant CL from leaking inside or outside the cell frame 120. The sealing members 500a, 500b, 500c may be formed by applying an adhesive that exhibits sealing properties. The adhesive is not particularly limited by its material as long as it exhibits sealing performance and has impact resistance, adhesiveness, and electrical insulation properties. In an aspect, the adhesive may include a 2-liquid type epoxy-based material in which a hardener is mixed in a base material. Further, in another aspect, a foam tape, sealant, silicone rubber O-rings, etc. mat be applied as the sealing members 500a, 500b, 500c.

Referring to FIGS. 19 and 28, a battery assembly according to an aspect of the present disclosure may include a rib bracket 120BK for connecting a separating part 120M and a top cell frame 120a. The rib bracket 120BK may protrude from the separating part 120M to the top cell frame 120a. The rib bracket 120BK may extend from the separating part 120M to the top cell frame 120a between the battery cells 110. The upper end of the rib bracket 120BK may be connected to the top cell frame 120a. In an aspect, the upper end of the rib bracket 120BK may be bolt-coupled to the top cell frame 120a.

The cell frame 120 should be able to withstand the internal pressure caused by the circulation of the coolant CL. The internal pressure caused by the circulation of the coolant CL may increase to a considerable level due to the pressure required for the coolant CL to move from the inlet port 121 to the outlet port 122. If the cell frame 120 fails to withstand the internal pressure caused by the circulation of the coolant CL and becomes deformed or damaged, the coolant CL may easily leak.

In particular, due to pressure caused by the circulation of coolant CL, a lifting deformation may occur in the central region of the top cell frame 120a. Thus, in this aspect, a rib bracket 120BK for connecting the separating part 120M and the top cell frame 120a is provided to prevent the top cell frame 120a from being lifted up due to the circulating pressure of the coolant CL. Because the top cell frame 120a is connected and fixed to the middle cell frame 120b via the rib bracket 120BK, the top cell frame 120a maintains its shape without being lifted up.

Further, while the cell cover 120d is coupled to the rib bracket 120BK, the cell cover 120d may be coupled to the middle cell frame 120b. This can prevent the cell cover 120d from being lifted up due to the circulating pressure of the coolant CL in the terminal cooling flow path 300T.

Meanwhile, another part of the rib bracket 120BK may protrude from the separating part 120M to the bottom cell frame 120c.

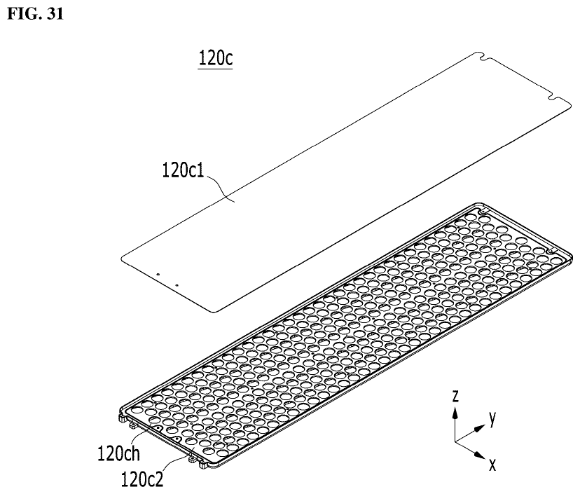

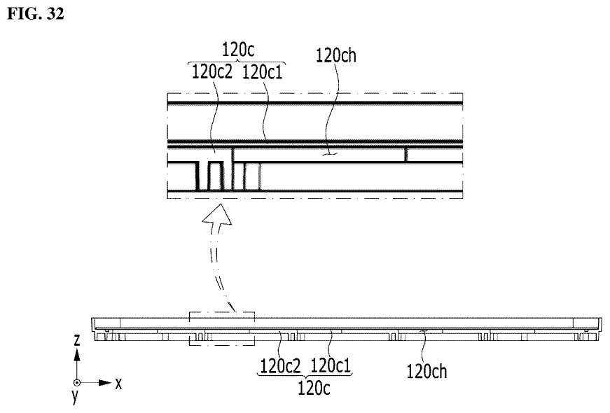

FIG. 31 is an exploded perspective view showing the bottom cell frame of FIG. 30. FIG. 32 is a cross-sectional view showing a cross section taken along the cutting line L-L′ of FIG. 30.

Referring to FIGS. 5, 9 to 11, and 29 to 32 together, the bottom cell frame 120c according to an aspect of the present disclosure may include a first bottom frame 120c1 and a second bottom frame 120c2. The first bottom frame 120c1 may be a plate or film in a flat shape, and the second bottom frame 120c2 may be a member including a bottom cell frame hole 120ch.

As previously described, when if a thermal event or thermal runaway occurs inside the battery cell 110, high-temperature venting gas or particles may be discharged through the opened vent part 110V. The battery assembly 100 according to this aspect may have a directional venting structure that guides the discharge of vent gas in a designed direction through the vent part 110V of the battery cell 110. The bottom cell frame 120c supports the battery cells 110 in normal times, however, when venting gas is discharged from the vent part 110V of the battery cell 110, the venting gas can be effectively discharged below the bottom cell frame 120c.

Generally, when gas is emitted from the battery cell 110, electrode plate fragments or active material fragments inside the battery cell 110 can be discharged to the outside at a high temperature. Such high-temperature particles may appear in the form of sparks. The high-temperature venting gas or particles discharged through the vent part 110V may tear or melt the first bottom frame 120c1 of the bottom cell frame 120c, then pass through the bottom cell frame hole 120ch of the second bottom frame 120c2 and be discharged to the outside of the bottom cell frame 120c. Although not specifically shown in the figure, the high-temperature venting gas or particles may be discharged to the outside through a separate venting channel provided below the bottom cell frame 120c.

The first bottom frame 120c1 may have a thin plate-like shape so that the first bottom frame 120c1 is easily torn or melted by venting gas or particles. Further, the bottom cell frame holes 120ch may be located in alignment with each battery cell 110. For example, when viewed along a direction perpendicular to one surface of the bottom cell frame 120c, at least a part of the bottom cell frame holes 120ch may overlap with the vent part 110V of the battery cell 110.

In FIGS. 31 and 32, the first bottom frame 120c1 is depicted as being located at an upper part of the second bottom frame 120c2, but in another example of the present disclosure, the first bottom frame 120c1 may be located at a lower part of the second bottom frame 120c2. In this case, the venting gas may first pass through the bottom cell frame hole 120ch of the second bottom frame 120c2 and then tear or melt the first bottom frame 120c1. Also, although not specifically shown in the figure, a structure of the bottom cell frame 120c in which the first bottom frame 120c1 and the second bottom frame 120c2 are integrated into one frame may also be included in the present disclosure.

The third sealing member 500c located on the bottom cell frame 120c can cover the vent part 110V of the battery cell 110 and a part of the side surface of the battery cell 110 that is adjacent to the lower surface of the battery cell 110. As a result, even if thermal runaway occurs due to an abnormality in any of the battery cells 110, high-temperature venting gas or particles are not transmitted to the surrounding battery cells 110, thereby making it possible to block chain ignition.

The venting path of the battery cell 110 and the coolant CL may be separated from each other by the third sealing member 500c. If the coolant CL and the venting gas or particles come into contact with each other, an unexpected situation may occur. In an aspect, insulating oil may be applied to the coolant CL. Since insulating oil is an oil component, it may cause further thermal runaway, fire, or explosion when in contact with venting gas or particles. The third sealing member 500c may cover the vent part 110V so that the vent part 110V is not exposed to the coolant CL. The third sealing member 500c blocks high-temperature venting gas and particles discharged from the vent part 110V of the battery cell 110 from coming into contact with the coolant CL, thereby making it possible to prevent thermal runaway of the battery cell 110 from leading to ignition or explosion of the entire battery assembly 100.

Referring to FIGS. 9 to 11, 25, and 28, a hook-coupling between a rib 120R and a groove 120G may be formed between the top cell frame 120a and the middle cell frame 120b.

In an aspect, the rib 120R may be formed on the outer circumference of the region where the battery cells 110 are located within the top cell frame 120a. The groove 120G may be formed on the outer circumference of the region where the battery cells 110 are located in the middle cell frame 120b. The groove 120G may be formed on the second side surface part 120S2 of the middle cell frame 120b. For example, the groove 120G may be formed on the upper end of the second side surface part 120S2.

The rib 120R of the top cell frame 120a may be hook-coupled with the groove 120G of the middle cell frame 120b. While forming this hook coupling, a sliding-prevention assembly structure may be realized between the top cell frame 120a and the middle cell frame 120b. Due to the hook coupling between the rib 120R and the groove 120G, the length of the waterproof interface between the top cell frame 120a and the middle cell frame 120b can be increased, thereby improving the waterproof sealing performance.

A sliding-prevention assembly structure can be realized by a hook coupling in which the rib 120R and the groove 120G are alternatively coupled. Thereby, the top cell frame 120a and the middle cell frame 120b can stably withstand the internal pressure caused by the circulation of the coolant CL. Due to the pressure required for the coolant CL to move from the inlet port 121 to the outlet port 122, the internal pressure caused by the circulation of the coolant CL can increase to a considerable level. If the cell frame 120 fails to withstand the internal pressure caused by the circulation of the coolant CL and becomes deformed, the coolant CL may easily leak. Therefore, it is a critical issue that the cell frame 120 can withstand the internal pressure caused by the circulation of the coolant CL. In this aspect, a sliding-prevention assembly structure can be realized by a hook coupling in which the rib 120R and the groove 120G are alternatively coupled. Thereby, the cell frame 120 can stably withstand the internal pressure caused by the circulation of the coolant CL.

A part of the first sealing member 500a may be located at the portion where the rib 120R and the groove 120G are hook-coupled. A part of the first sealing member 500a may be filled in the portion where the rib 120R and the groove 120G are hook-coupled. Due to the first sealing member 500a filled in the portion where the rib 120R and the groove 120G are hook-coupled, the coupling force between the top cell frame 120a and the middle cell frame 120b is increased, and the coolant CL can be blocked from leaking through the gap between the top cell frame 120a and the middle cell frame 120b.

Referring again to FIGS. 9 to 11, the cell frame 120 according to this aspect may include a distribution mechanism 200. The distribution mechanism 200 may include an inlet distribution mechanism 210 disposed adjacent to the inlet port 121. The inlet distribution mechanism 210 may be provided between the inlet port 121 and the battery cells 110.

The inlet distribution mechanism 210 may include a partition wall and a plurality of distribution holes formed in the partition wall. Such distribution holes may be located to correspond to the rows in which the battery cells are disposed. The coolant CL flowing-in through the inlet port 121 does not immediately enter into the space where the battery cells are located, but rather flows into the space where the battery cells are located while being distributed through the distribution hole. Thereby, the coolant CL is not concentrated in only some of the large number of battery cells 110, but instead the coolant CL can be evenly distributed so that it flows throughout the battery cells 110. Consequently, uniform cooling of all of the battery cells 110 can be performed, which can lead to an improvement in performance of the battery assembly.

Additionally, the distribution mechanism 200 may include an outlet distribution mechanism 220 located adjacent to the outlet port 122. The outlet distribution mechanism 220 may be provided between the outlet port 122 and the battery cells 110. The outlet distribution mechanism 220 may also include a partition wall and a plurality of distribution holes formed in the partition wall. Similar to the inlet distribution mechanism 210, the outlet distribution mechanism 220 may also provide the function of directing the coolant CL so as to evenly distribute the flow of the coolant CL throughout the battery cells 110. Not only providing the inlet distribution mechanism 210 at the inlet port 121, but also providing the outlet distribution mechanism 220 at the outlet port 122 may thereby prevent problems of the coolant CL becoming stagnant and not flowing well, or in which vortices are formed in the coolant CL. The outlet distribution mechanism 220 does not directly distribute the coolant CL to the plurality of cooling flow paths, but rather guides the plurality of cooling flow paths to ultimately discharge smoothly through the outlet port 122, thereby minimizing flow loss of the coolant CL and improving cooling efficiency.

Referring again to FIG. 22, the busbar assembly 130 may include a sensing member 133. The sensing member 133 may be configured to sense voltage data or thermal data of the battery cells 110. In an aspect, the sensing member 133 may be connected to the terminal parts 111, 112 of the battery cells 110 or the busbar members 131. Thereby, it is possible to sense voltage data of the battery cells 110 and transmit the data to the outside. A part of the sensing member 133 may be exposed to the outside of the cell frame 120. The sensing member 133 is not limited by shape or type as long as it can transmit voltage data or thermal data. In an aspect, it may be a flexible printed circuit board (FPCB) or a flexible flat cable (FFC).

In another aspect (not shown), the busbar members 131 may be shaped so as to help increase thermal transmission to the coolant CL flowing past and contacting the busbar members 131. For example, one or more surfaces of the busbar members 131 may have one or more structural features that increase the surface area of the busbar members 131 in contact with the coolant CL. In some examples, such structures may take the form of spaced-apart outward projections (or conversely inward recesses) from one or more surfaces of the busbar members 131 similar to fins or pins of a heat sink, so that the coolant CL can flow in between the projections (or other surface features) in order to increase the heat dissipation from the busbar members 131 to the coolant CL.

Referring again to FIG. 1, the battery assembly 100 according to an aspect of the present disclosure shown in FIG. 1 can be mounted directly on a vehicle or chassis by itself. That is, in the case of the battery assembly 100 according to this aspect, the battery cells 110 can be mounted directly on a vehicle or chassis while being stored in a cell frame 120. The inlet port 121 and the outlet port 122 of the cell frame 120 may be connected to a coolant circulation system within the vehicle.

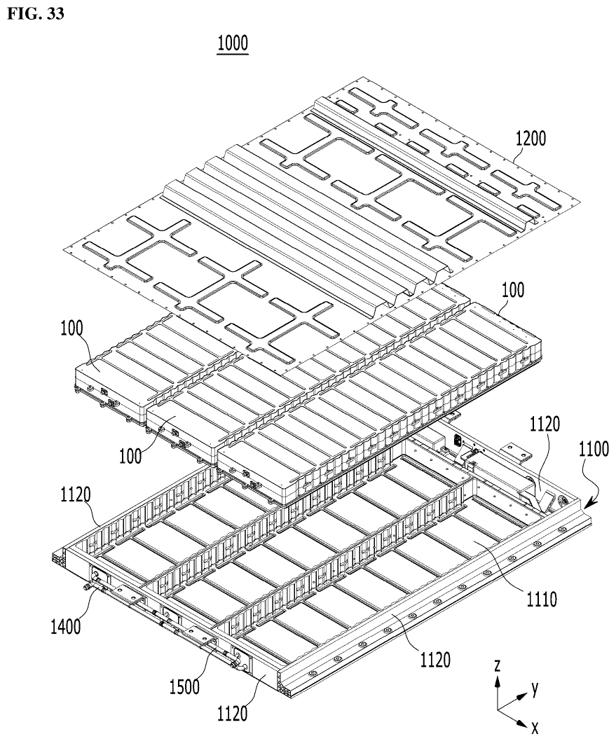

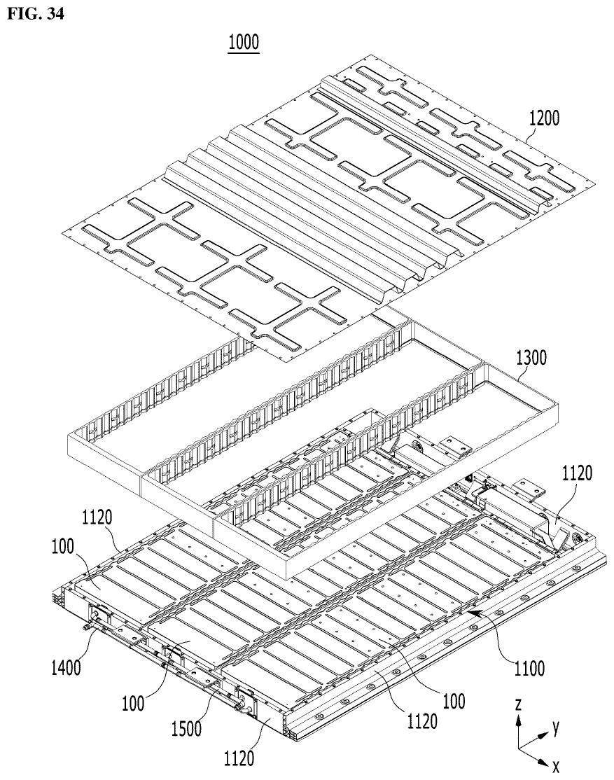

FIGS. 33 and 34 are exploded perspective views showing a battery pack according to an aspect of the present disclosure.

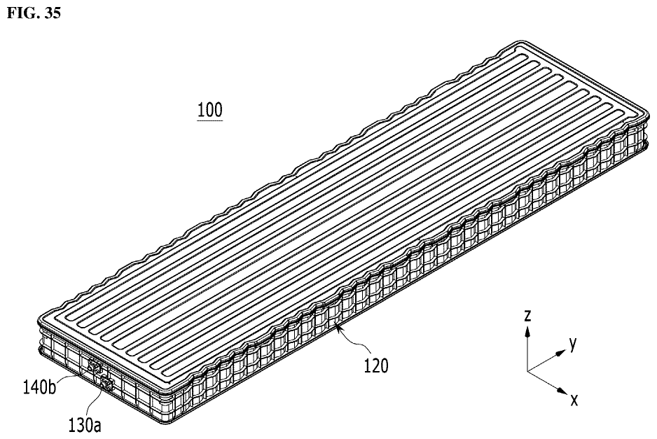

Referring to FIGS. 1, 33, and 34, a battery pack 1000 according to another aspect of the present disclosure may include at least one battery assembly 100; a pack frame 1100 that stores at least one battery assembly 100 and is opened on one side; and a pack cover 1200 that covers the opened side of the pack frame 1100. In an aspect, FIGS. 34 and 35 illustrate that three battery assemblies 100 may be stored in the pack frame 1100.

The pack frame 1100 may include a bottom part 1110 and a side beam 1120. At least one battery assembly 100 may be placed on the bottom part 1110. The side beam 1120 may extend along the edge of the bottom part 1110, and may extend in a direction perpendicular to one surface of the bottom part 1110. An internal space having an opened upper part may be provided by the bottom part 1110 and the side beam 1120, and the battery assembly 100 may be stored in this internal space. The pack cover 1200 may cover the upper surface of the battery assembly 100 mounted on the pack frame 1100.

The battery pack 1000 according to this aspect may include a filling member 1300 foamed in the space inside the pack frame 1100 and the pack cover 1200. The filling member 1300 according to this aspect may be a foamed member. The filling member 1300 may be a foamed member that is filled in the space inside the pack frame 1100 and the pack cover 1200 and then foamed.

The filling member 1300 according to this aspect may be formed of a resin or the like. The filling member 1300 may include an air pocket, and an adhesive may be provided in this air pocket. The filling member 1300 may be a foamed rubber, i.e., cellular or sponge. The filling member 1300 may include an air-filled matrix structure. The filling member 1300 may be based on, for example, silicone, polyurethane, or other organic materials.

For example, the filling member 1300 may be applied onto the pack frame 1100 and foamed into a plate shape, or may be foamed using a spray. The filling member 1300 may include a foaming accelerator.

When the filling member 1300 comes into contact with other components, it can become hardened and coupled with the other components to fix and support them. Therefore, the adhesive force between the components that the filling member 1300 contacts may be made strong. In this aspect, the adhesive force between the pack frame 1100, the pack cover 1200, and the battery assemblies 100 may be made strong by the filling member 1300. In addition, the filling member 1300 can absorb vibration and impact applied to the battery pack 1000, so that components within the battery pack 1000 are not separated or detached, thereby improving the safety and mechanical reliability of the battery pack.

The battery pack 1000 according to this aspect may include an inlet pipe 1400 connected to the inlet port 121 of the battery assembly 100 and an outlet pipe 1500 connected to the outlet port 122 of the battery assembly 100.

Each of the inlet pipe 1400 and the outlet pipe 1500 may pass through the side beam 1120 and be connected to the inlet port 121 and the outlet port 122 of the battery assembly 100. Further, the inlet pipe 1400 and the outlet pipe 1500 may be connected to a coolant circulation system inside the vehicle. The coolant supplied by the coolant circulation system inside the vehicle may reach the inlet port 121 through the inlet pipe 1400. The coolant circulating inside the battery assembly 100 and discharged through the outlet port 122 may be collected by the coolant circulation system again through the discharge pipe 1500.

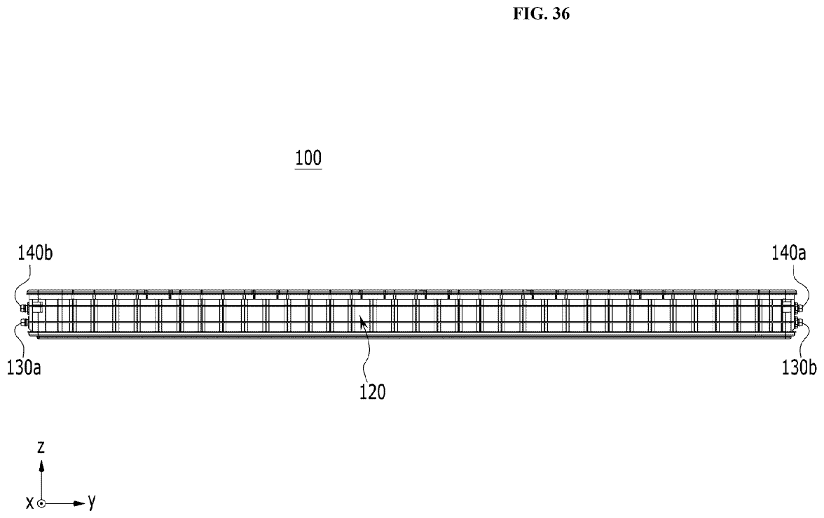

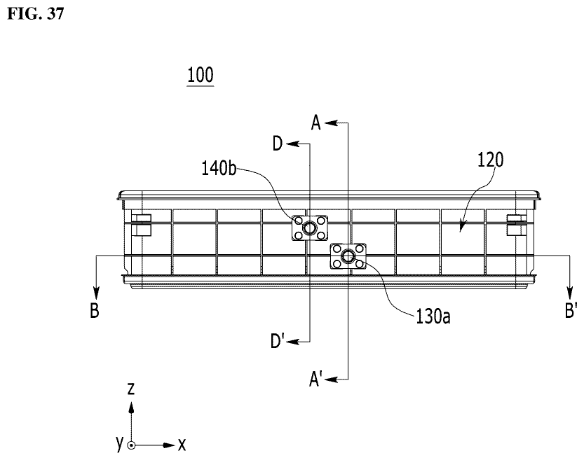

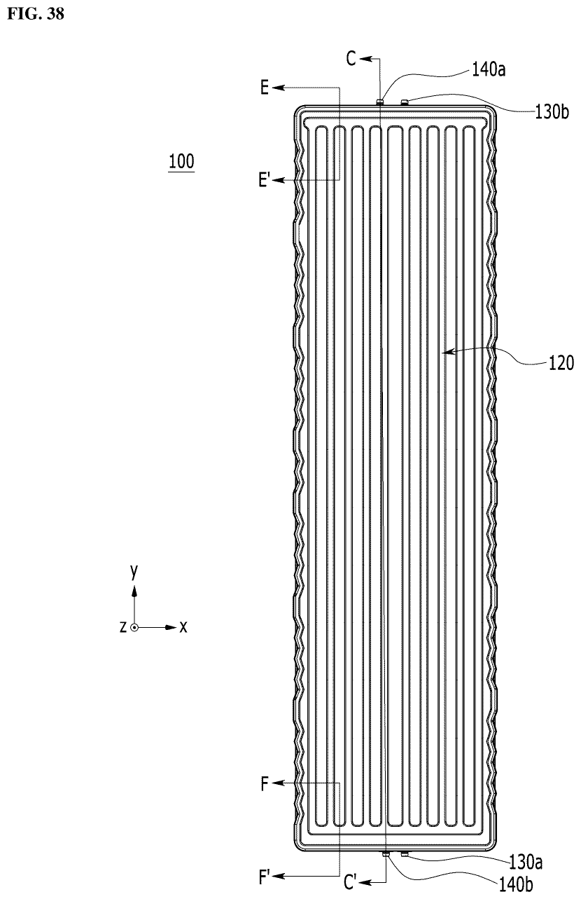

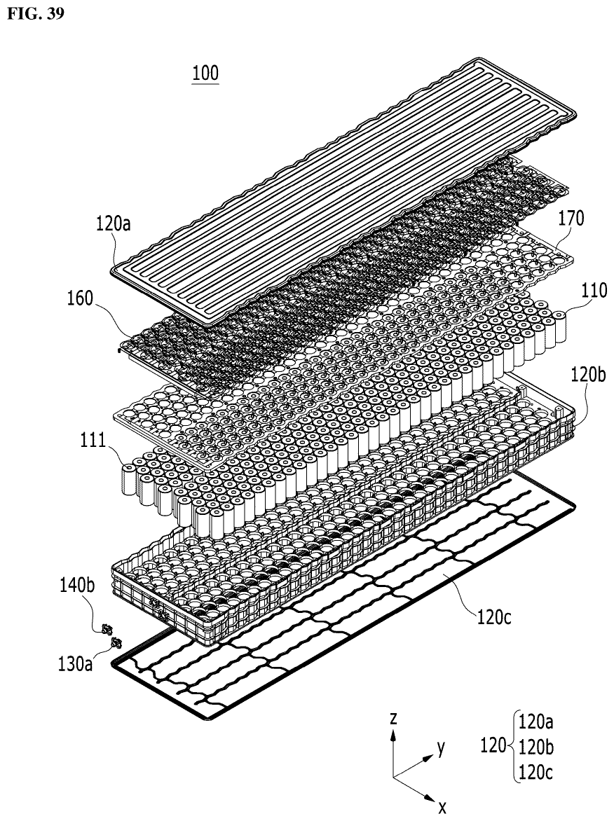

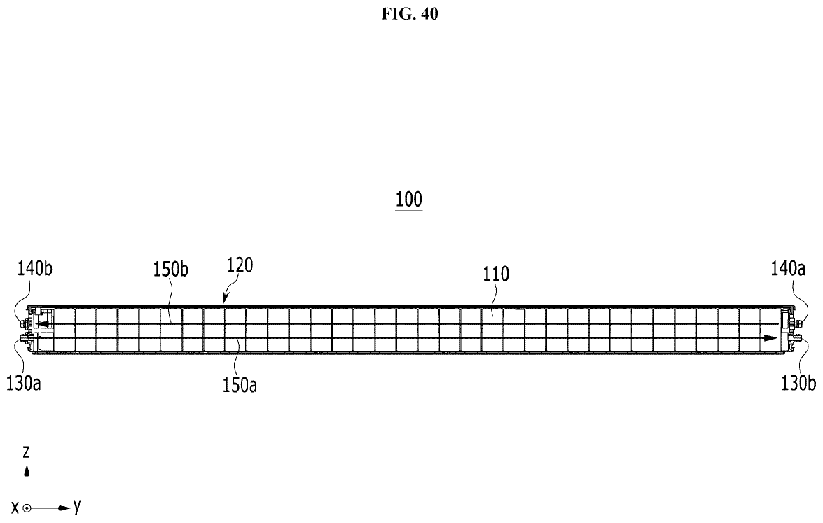

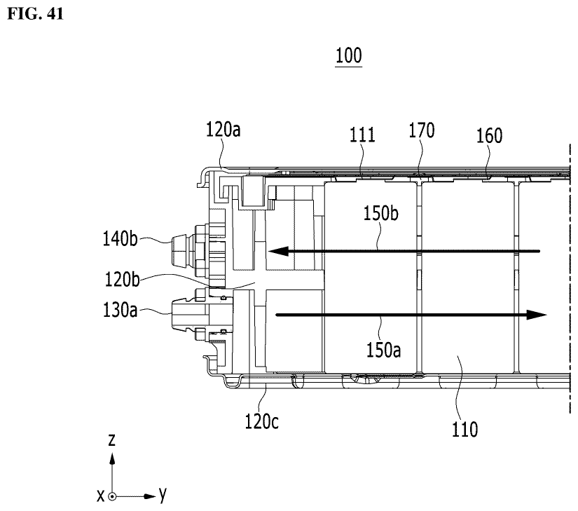

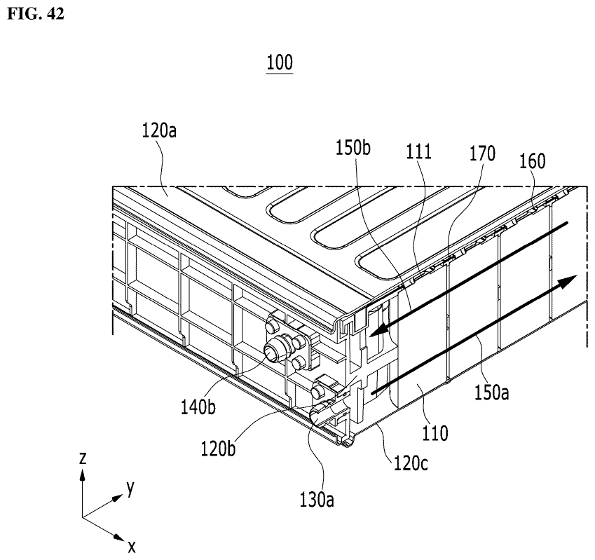

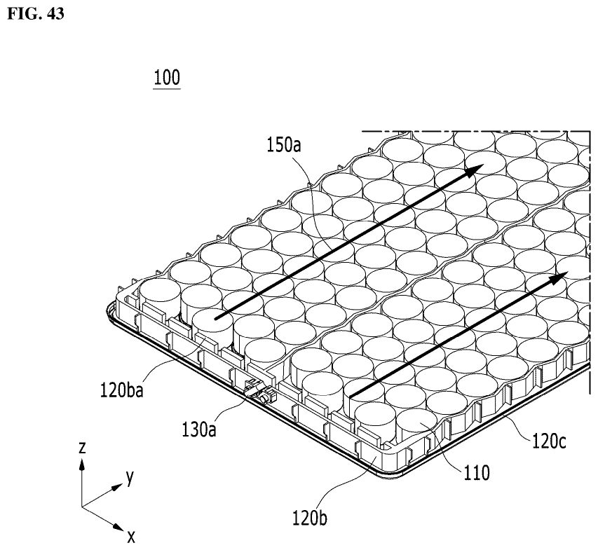

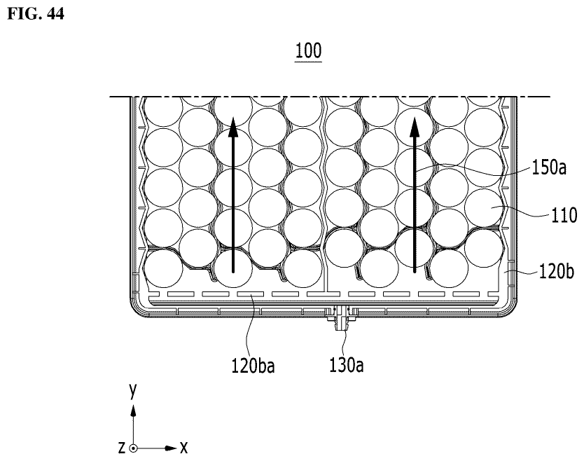

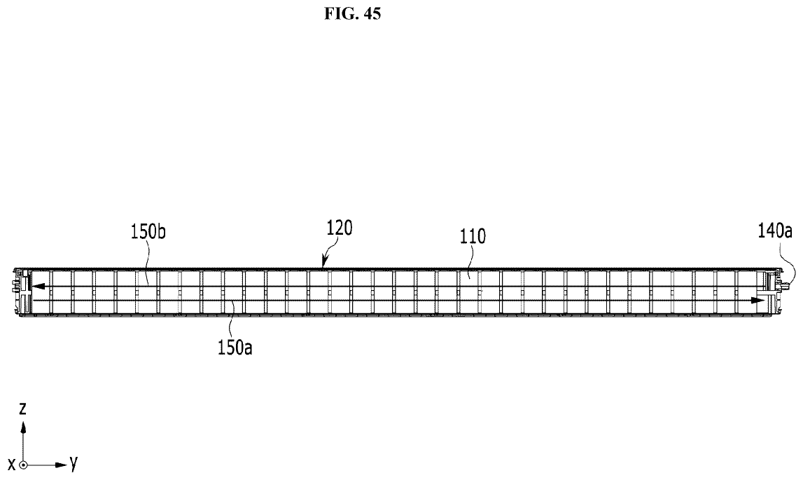

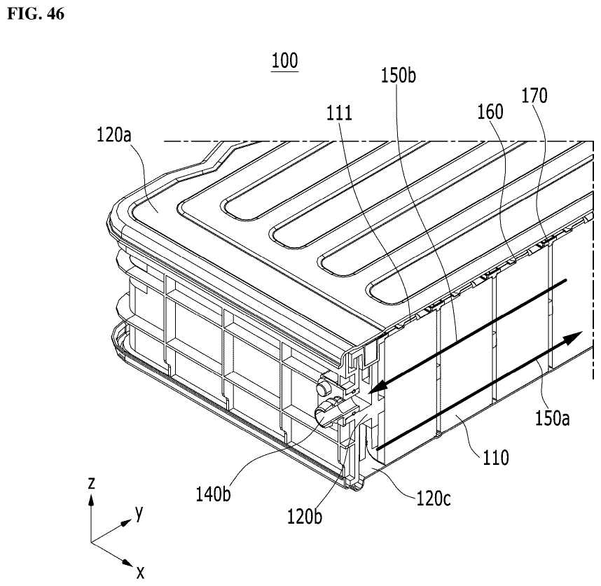

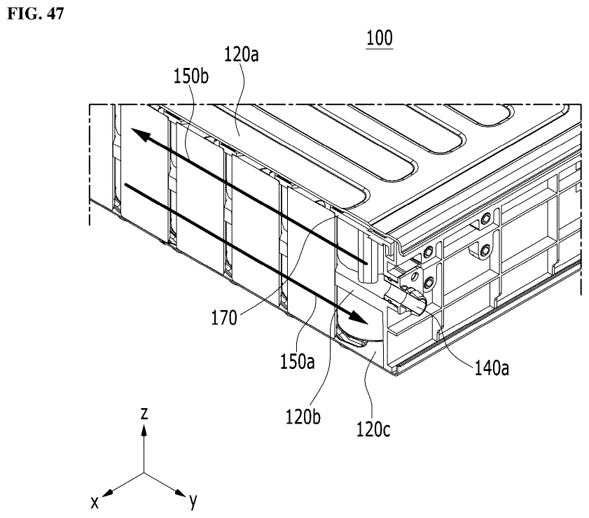

FIG. 35 is a perspective view showing a battery assembly 100 according to another aspect of the present disclosure. FIG. 36 is a side elevation view showing the battery assembly 100 of FIG. 1. FIG. 37 is a front elevation view showing a state of the battery assembly 100 of FIG. 35, viewed from an angle different from that of FIG. 36. FIG. 38 is a top plan view showing a state of the battery assembly 100 of FIG. 35, viewed from an angle different from that of FIGS. 36 and 37. FIG. 39 is an exploded perspective view showing the battery assembly 100 of FIG. 35. FIG. 40 is a cross-sectional view showing a cross section taken along the cutting line A-A′ of FIG. 37. FIG. 41 is an enlarged cross-sectional view showing a region of FIG. 40. FIG. 42 is a perspective view showing the partially enlarged cross-section of FIG. 41. FIG. 43 is a perspective view showing a portion of a cross section taken along the cutting line B-B′ of FIG. 37. FIG. 44 is a top plan view of the portion of the cross section of FIG. 43. FIG. 45 is a cross-sectional view showing a cross section taken along the cutting line C-C′ of FIG. 38. FIG. 46 is a perspective view showing a partially enlarged cross-section of one end of the battery assembly 100 taken along the cutting line D-D′ of FIG. 37 and the cutting line C-C′ of FIG. 38. FIG. 47 is a perspective view showing a partially enlarged cross-section of another end of the battery assembly 100, opposite to the end of the battery assembly 100 shown in FIG. 46, taken along the cutting line C-C′ of FIG. 38.

Referring to FIGS. 35 to 47, a battery assembly 100 according to an aspect of the present disclosure includes: a plurality of battery cells 110; a cell frame 120 in which the battery cells 110 are housed; and a first inlet port 130a, a second inlet port 140a, a first outlet port 130b, and a second outlet port 140b for circulating a coolant. The coolant circulates through the inside of the cell frame 120 while being in direct contact with the battery cells 110. A first coolant path 150a through which the coolant flows from the first inlet port 130a to the first outlet port 130b and a second coolant path 150b through which the coolant flows from the second inlet port 140a to the second outlet port 140b are separated from each other. At least a part of the coolant flowing through the second coolant path 150b is in contact with a terminal part 111 of the battery cells 110.

The battery assembly 100 according to this aspect may include a plurality of battery cells 110. As with the above aspects, the battery cells 110 according to this aspect may be various types of battery cells, for example, a pouch type battery cell, a prismatic battery cell, or a cylindrical battery cell. In an aspect, as shown in FIG. 39, the battery cell 110 according to this aspect may be a cylindrical battery cell. The following describes a cylindrical battery cell, but the battery cell according to this aspect is not limited thereto, and various types of battery cells may be applied.

The cell frame 120 according to this aspect may be located while covering part of the upper surface, lower surface, and side surfaces of the battery cells 110, as shown in FIG. 39. The cell frame 120 may serve to protect the battery cells 110 and electrical components connected thereto from external physical impact.

The cell frame 120 is partially opened so that the electrodes of the plurality of battery cells 110 housed may be exposed to the outside, and busbars may be located on the periphery of the opened region. The battery cells 110 may be inserted and housed in the cell frame holes provided in the cell frame 120. The cell frame 120 may be provided in various shapes and materials so that the plurality of battery cells 110 are received therein. The cell frame 120 may be made of a metal material to maintain a predetermined rigidity, but is not limited thereto. In an aspect, the cell frame 120 may be formed by injection molding.

As with the above aspects, a cooling flow path may be formed inside the cell frame 120. The cooling flow path may allow the coolant to flow while being in direct contact with at least a part of the battery cells 110.

The structure of the cell frame 120 may vary. The cell frame 120 may be in the form of a metal plate in which an upper surface, a lower surface, and both side surfaces are integrated. A mono frame may be manufactured by extrusion molding. However, the structure of the cell frame 120 is not limited thereto, and may be provided in various structures not described in the above-described examples. The battery assembly 100 according to this aspect may include a plurality of battery cells 110. The plurality of battery cells 110 may be arranged along the xy plane of FIG. 39, while standing upright so that the side surfaces of the main body of the battery cells 110 face each other. The terminal parts 111 of the battery cells 110 may protrude along the +z-axis direction of FIG. 39.

The coolant according to this aspect may flow into the cell frame 120 through the first inlet port 130a and the second inlet port 140a, and then be discharged to the outside of the battery assembly 100 through the first outlet port 130b and the second outlet port 140b, respectively. In arrangements in which the coolant comes into direct contact with the battery cells 110, other electrical components, the terminal assembly, and the like within the battery assembly 100, it needs to be electrically insulated. In such case, the coolant may be a material with insulating properties, such as insulating oil. However, these are example materials, and as described above, any material that can cool an object requiring cooling can be applied to the coolant in the present disclosure without limitation.

The coolant may be circulated inside the cell frame 120 to manage the heat of the battery cells 110 by dissipating the heat of the battery cells 110.

A first coolant path 150a through which the coolant flows from the first inlet port 130a to the first outlet port 130b may be provided. A second coolant path 150b through which the coolant flows from the second inlet port 140a to the second outlet port 140b may be provided. The first coolant path 150a and the second coolant path 150b may be separated from each other to form independent cooling paths having independent flow of coolant from one another. The separation of the first coolant path 150a and the second coolant path 150b may be achieved through a partition wall structure formed inside the cell frame 120. At least a part of the coolant flowing through the second coolant path 150b may come into contact with the terminal parts 111 of the battery cells 110, thereby cooling the heat generated at the terminal parts 111.

The cell frame 120 may include a bottom cell frame 120c, a middle cell frame 120b, and a top cell frame 120a. The bottom cell frame 120c may have a structure in which the battery cells 110 are seated. The middle cell frame 120b may provide a flow path for cooling the body portion of the battery cell 110. The top cell frame 120a may have a structure that fixes the upper end of the battery cells 110 and allows a busbar to be seated. The first coolant path 150a may be formed through the space between the bottom frame 120c and the middle frame 120b. The second coolant path 150b may be formed through the space between the middle frame 120b and the top frame 120a. The coolant may flow in through the first inlet port 130a and flow along the first coolant path 150a, and cool the lower portions of the battery cells 110. At the same time, the coolant flowing in through the second inlet port 140a may flow along the second coolant path 150b, and cool the upper portions of the battery cells 110, as well as the terminal parts 111.

According to this aspect, the first inlet port 130a and the second inlet port 140a are provided at mutually different positions to supply a coolant independently, and the first outlet port 130b and the second outlet port 140b may discharge respective coolants separately. The coolant supplied from the first inlet port 130a may move along the first coolant path 150a and uniformly cool respective battery cells 110, and the coolant supplied from the second inlet port 140a may move along the second coolant path 150b and uniformly cool respective battery cells 110. A part of the coolant flowing through the second coolant path 150b may be directed so as to come into contact with the terminal parts 111 of the battery cells 110, similar to the terminal cooling flow path 300T of FIGS. 13-14, thereby suppressing localized heat accumulation. Since the terminal parts 111 are locations where current is concentrated, localized heat generation may be quickly alleviated by such a separate coolant flow. By appropriately setting the length and cross-sectional area of each path, coolant flow resistance can be minimized and the uniformity of the temperature distribution can be improved.

As a result, the separated coolant paths supply coolant in parallel from the first inlet port 130a and the second inlet port 140a and discharge it separately from the first outlet port 130b and the second outlet port 140b, thereby reducing temperature deviation across the battery cells. Even if heat rises along one of the coolant paths, the other coolant path independently performs cooling, so that a uniform temperature may be imparted to the battery cells 110. The coolant may thus cool the outer surfaces of the battery cells 110 as well as the terminal parts 111 in a balanced manner, so that, even when the battery assembly 100 is operated for long periods of time, the temperature rise can be suppressed and the lifespan can be extended.

Referring again to FIGS. 35 to 47, the first inlet port 130a and the second outlet port 140b are arranged on one side (end) of the cell frame 120, and the second inlet port 140a and the first outlet port 130b may be arranged on the other side (end) of the cell frame 120.

According to this aspect, the one side and the other side of the cell frame 120 may be located opposite to each other, such as at opposite ends of the cell frame 120 along the longitudinal dimension of the cell frame 120. By distributing and arranging the inlet ports and the outlet ports on opposing sides of the cell frame 120, the flow of coolant can be evenly distributed.

The ports may be arranged symmetrically on both sides of the cell frame 120. At one side of the cell frame 120, a first inlet port 130a may be located at the lower portion, and a second outlet port 140b may be located at the upper portion. At the other side surface of the cell frame 120, a second inlet port 140a may be located at the upper portion, and a first outlet port 130b may be located at the lower portion. The respective ports may be connected to an external cooling system via a connector or fitting. The ports can be molded integrally with the side surfaces of the cell frame 120 or assembled via separate connectors. The coolant may form a cross-flow, in which coolant entering each side (end) is discharged to the opposite side (end). The inlet port and the outlet port are distributed and arranged on both opposing sides, so that the coolant may flow evenly and be distributed uniformly to all battery cells 110 within the cell frame 120, while minimizing stagnant zones, so as to achieve a uniform cooling effect across all of the battery cells 110. That is, the first inlet port 130a and the first outlet port 130b are located on mutually opposing sides of the cell frame 120, so that the coolant flowing along the first coolant path 150a may evenly cool all of the battery cells 110. Similarly, through the arrangement of the second inlet port 140a and the second outlet port 140b on opposing sides of the cell frame 120, the coolant of the second coolant path 150b can also provide uniform cooling. The cross-arrangement minimizes coolant flow resistance and reduces pressure loss.

Referring again to FIGS. 35 to 47, the first coolant path 150a and the second coolant path 150b may be spaced apart from one another along the z-axis, which corresponds to the longitudinal dimension of the battery cell 110. The longitudinal dimension of the battery cell 110 according to this aspect may generally be the axial dimension of the battery cell. That is, where the battery cell 110 is cylindrical, the longitudinal dimension may be the dimension along the central axis defining the radius of the cylinder of the cylindrically-shaped battery cell. By spacing the coolant paths apart along the longitudinal dimensions of the battery cells 110, effective contact with the entire surface of each battery cell 110 is thereby enabled. The coolant paths may be formed in parallel to the side surfaces of the battery cells 110.

Referring again to FIGS. 35 to 47, the coolant flowing through the first coolant path 150a and the second coolant path 150b can flow in mutually opposite directions.

According to this aspect, when the coolant of the first coolant path 150a flows in one direction, the coolant of the second coolant path 150b may flow in the opposite direction. If the coolant of the first coolant path 150a flows from left to right, the coolant of the second coolant path 150b can flow from right to left. This method can maximize heat exchange efficiency.

Specifically, the coolant flowing in through the first inlet port 130a may flow from left to right of the cell frame 120 and cool the lower portion of the battery cells 110, and, at the same time, the coolant flowing in through the second inlet port 140a may flow from right to left of the cell frame 120 and cool the upper portion of the battery cells 110. Through this arrangement, coolants having relatively different temperatures at each position may cool the battery cells 110. The flow rate of each path can be independently adjusted through a flow rate control valve and/or a separate pump can be used to control the flow rate of the coolant supplied to each inlet port. The coolant flowing into the first inlet port 130a may flow along the first coolant path 150a toward the first outlet port 130b. At the same time, the coolant flowing into the second inlet port 140a may flow along the second coolant path 150b toward the second outlet port 140b. As the two coolant flows progress in mutually opposite directions, the temperature gradients at each position of battery cell 110 can be offset. This type of coolant flow may contribute to minimizing the overall temperature deviations. In other words, this structure may minimize the temperature gradient across the entire region of the array of battery cells 110.

As a result, this method may minimize the temperature gradient of the coolant and effectively reduce temperature deviations between battery cells 110. It is possible to prevent the problem that cooling is concentrated in only certain sections and maintain a uniform temperature distribution as a whole. That is, the coolant flowing in mutually opposite directions may offset temperature differences at each position, thereby achieving a uniform temperature distribution as a whole. Further, it is possible to effectively resolve imbalances caused by temperature differences between the battery cells 110 located on the inlet and outlet sides. In other words, by providing unidirectional flow within each coolant path, a large temperature difference will occur between the battery cells 110 located on the inlet and outlet sides along each coolant path, as discussed above in connection with the arrangement illustrated in FIGS. 9 to 11. However, in contrast to that arrangement of FIGS. 9 to 11, where the inlet to the first cooling flow path 300a was via the connecting hole 123, which was also the outlet of the second cooling flow path 300b (and thus the coolant temperature entering the first cooling flow path 300a is approximately the same as the coolant temperature exiting the second cooling flow path 300b), the first and second coolant paths 150a, 150b of FIGS. 35 to 47 are separately supplied with coolant by respective first and second inlet ports 130a, 140a. Therefore, although temperature gradients will continue to be present along the coolant flow direction, the coolant temperature proximate both inlet ports 130a, 140a should be approximately the same as the supplied coolant temperature, rather than the temperature of the coolant entering the second coolant path 150b being an intermediate temperature that is the same as the temperature of the coolant exiting the first coolant path 150a, as would be the case in the arrangement of FIGS. 9-11. Thus, the coolant temperature differences between each inlet port 130a, 140a and the respective outlet port 130b, 140b of the aspect illustrated in FIGS. 35-47 should be smaller than the overall coolant temperature difference between the inlet port 121 and the outlet port 122 of the aspect illustrated in FIGS. 9-11.

Referring again to FIGS. 35 to 47, a part of the battery cell 110 may be in contact with the coolant flowing through the first coolant path 150a, while another part of the battery cell 110 may be in contact with the coolant flowing through the second coolant path 150b. Accordingly, the battery cells 110 may be in contact with different coolant paths in two regions divided along the height dimension. That is, the lower 50% of the height of the battery cell 110 may be in contact with the coolant of the first coolant path 150a, and the upper 50% may be in contact with the coolant of the second coolant path 150b. Thus, via the middle frame 120b of the cell frame 120, it is possible to physically separate the two coolant paths and also maintain contact with the battery cell 110. In alternative aspects, the height of the divider provided by the middle frame 120b may be at a different location along the height dimension. For example, the lower region of the battery cells 110 exposed to the first coolant path 150 a may be smaller than 50% such that the upper region exposed to the second coolant path 150b may be correspondingly larger than 50%, or vice versa. Such setting of the height location of the divider provided by the middle frame 120b may be done, for example, to balance expected heat dissipation by the battery cells 110, if it were expected that different regions along the height dimension would give off more heat than other regions during use.

This cooling method may effectively disperse localized heat concentration in the battery cell 110. More precise temperature control may be achieved through independent cooling of the upper and lower portions. Moreover, even more precise temperature control may be achieved by independent adjustability of the upper and lower portions. For example, instead of (or in addition to) setting the height location of the divider provided by the middle frame 120b, as discussed above, the temperature and/or flow rate (via pumps and/or valves) of the coolant entering each inlet may be independently adjustable. Each portion of the battery cells 110 may be in contact with an appropriate coolant path, thereby preventing localized overheating. Therefore, uniform cooling may be achieved as a whole, thereby improving the performance and lifespan of the battery cells 110. In addition, two independent coolant paths may take charge of mutually different regions of the battery cell 110, thereby improving cooling efficiency. It is possible to prevent cooling from being concentrated in a specific region and achieve a uniform temperature distribution. Even if a problem occurs in one coolant path, minimal cooling can be maintained through the other path.

Referring again to FIGS. 35 to 47, the coolant flowing through the first coolant path 150a may be in direct contact with the lower portion of the plurality of battery cells 110.

According to this aspect, the first coolant path 150a may be formed in the lower region of the cell frame 120. The first coolant path 150a may be formed in the space between the bottom frame 120c and the middle frame 120b. The coolant may pass through this space and come into direct contact with the lower portions of the battery cells 110. About one-third or more and one-half or less of the lower portions of the battery cells 110 may be exposed to the coolant of the first coolant path 150a. The heat generated from the lower portions of the battery cells 110 can thus be directly absorbed by the coolant and discharged to the outside. The bottom frame 120c may include holes into which the battery cells 110 are inserted, like the bottom cell frame holes 120ch illustrated in FIGS. 31-32. A space through which the coolant can flow may be formed along the lower portion of each hole. The coolant of the first coolant path 150a may flow while filling the space between the bottom frame 120c and the lower portion of the battery cell 110. The bottom frame 120c may be formed with one or more guide ribs for facilitating smooth flow of the coolant. Such guide ribs may take the form of those disclosed in Korean Patent Application No. 10-2025-0135083 filed on Sep. 19, 2025, the entire contents of which are incorporated herein by reference.

This cooling method may quickly remove heat that is apt to accumulate at the lower portion of the battery cell 110. It can work together with the convection effect caused by gravity to further improve the cooling efficiency. The lower cooling structure can effectively remove heat generated at the lower portion of the battery cell 110. The heat transfer efficiency can be maximized through direct contact with the coolant. Further, it is possible to maintain stable temperature at the lower portion of the battery cell 110, thereby contributing to the improvement of overall battery performance.

Referring again to FIGS. 1 to 13, the coolant flowing through the second coolant path 150b may be in direct contact with the upper portion of the plurality of battery cells 110.

According to this aspect, the second coolant path 150b may be formed in the upper region of the cell frame 120. The second coolant path 150b may be formed in the space between the top frame 120a and the middle frame 120b. The coolant may pass through this space and come into direct contact with the upper portions of the battery cells 110, as well as the terminal parts 111. Accordingly, the coolant may directly absorb heat generated from the upper portions of the battery cells 110, including from around the terminal parts 111.

This cooling method may effectively manage the heat generated intensively at the terminal part 111 during high-power charging and discharging. That is, it is possible to prevent overheating of the terminal 111, thereby improving the safety and lifespan of the battery. Since the terminal part 111 is a region where heat generation due to electrical resistance is concentrated, cooling through direct contact with the coolant can be very effective. By preventing overheating of the terminal part 111, the battery lifespan can be extended and the temperature uniformity of the entire battery cells 110 can be improved.

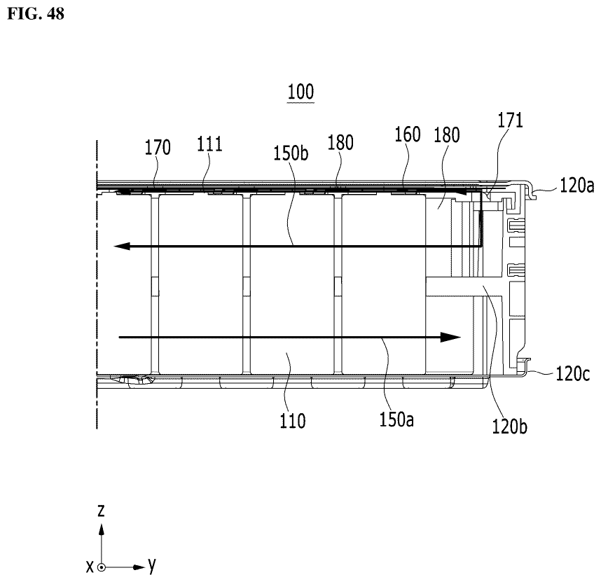

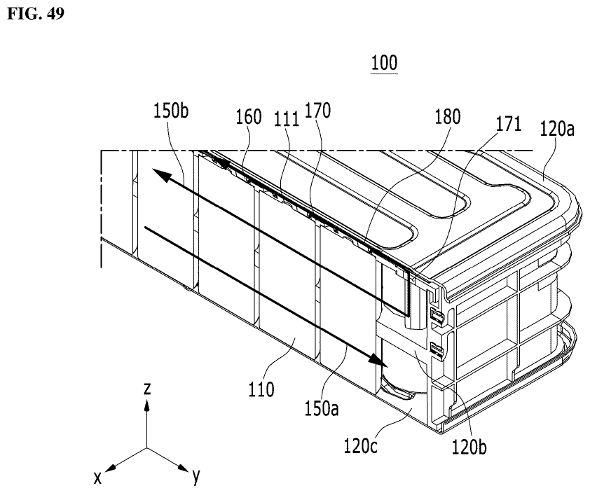

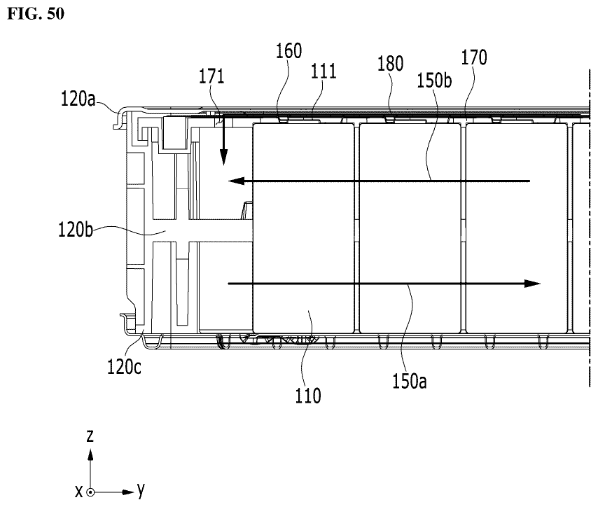

FIG. 48 is a cross-sectional view showing a cross section taken along the cutting line E-E′ of FIG. 38. FIG. 49 is a partial cross-sectional perspective view of the battery assembly 100 of FIG. 48. FIG. 50 is a cross-sectional view showing a cross section taken along the cutting line F-F′ of FIG. 38.

Referring to FIGS. 48 to 50, a busbar 160 electrically connected to a terminal part 111 is provided, and at least a part of the coolant flowing through the second coolant path 150b may come into contact with the busbar 160.

Each busbar 160 according to this aspect may be a conductive member that electrically connects the terminal parts 111 of the plurality of battery cells 110. The busbar 160 may serve to connect the plurality of battery cells 110 in series or parallel. The busbar 160 may serve to electrically connect the plurality of battery cells 110.

The busbar 160 may be made from copper, aluminum, or an alloy thereof. The coolant of the second coolant path 150b may effectively remove resistance heat generated during the conducting of electric current while flowing along the surface of the busbar 160. The busbar 160 may be connected to the positive electrode terminal part 111 of the battery cell 110 by welding or bolting. The coolant of the second coolant path 150b may be in direct contact with the lower surface of the busbar 160 and absorb the heat generated by the busbar 160. The busbar 160 may generate heat as electric current flows, and therefore may require cooling. The coolant flowing through the second coolant path 150b may come into direct contact with the busbar 160 and absorb the heat. By simultaneously cooling the terminal part 111 and the busbar 160, temperature rise in the electrical connection part can be effectively suppressed.

Cooling of the busbars 160 may effectively manage heat generation at the electrical connection part. This prevents an increase in electrical resistance due to overheating of the busbar 160 and improves the efficiency of the entire system. That is, by cooling the busbars 160, it is possible prevent an increase in connection resistance and improve energy efficiency.

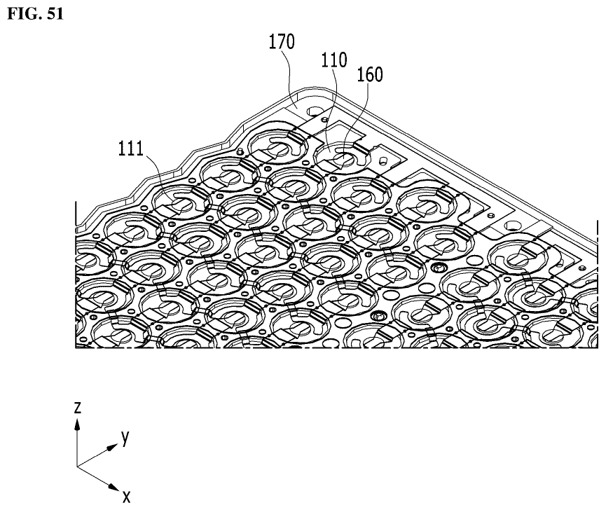

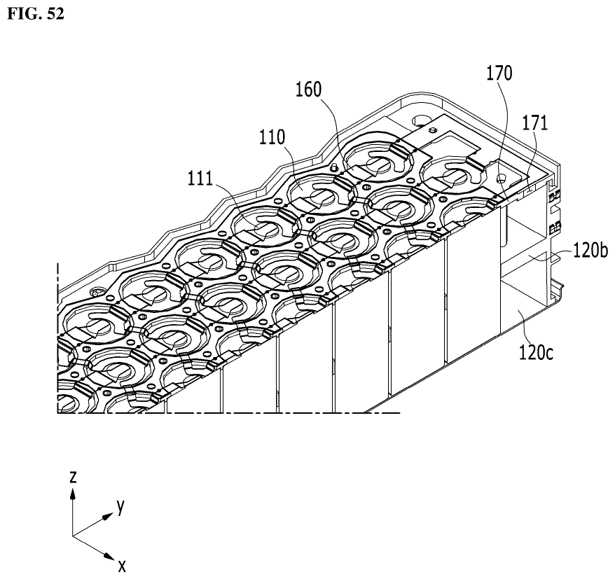

FIG. 51 is a partial perspective view showing a state in which the top frame 120a is removed in a battery assembly 100 according to an aspect of the present disclosure. FIG. 52 is a partial perspective view showing a state in which the top frame 120a is removed in a battery assembly 100 taken along the cutting line E-E′ of FIG. 38.

Referring to FIGS. 39, 41, 42, and 46 to 18, a busbar frame 170 may be provided to which busbars 160 are mounted.

The busbar frame 170 according to this aspect may be made from an insulating plastic or polymeric material. The busbar frame 170 includes grooves or slots for housing the busbars 160, so that the position of the busbars 160 may be accurately fixed. Through the design of the busbar frame 170, it is possible to optimize the flow path of the coolant and control the contact between the busbars 160 and the coolant. The busbar frame 170 may be injection molded from an engineering plastic material. The busbar frame 170 may be formed with grooves into which the busbars 160 are inserted. Each groove can enable precise positioning in correspondence to the shape of the busbar 160. The busbars 160 may be mounted in the grooves or slots formed in the busbar frame 170. The busbar frame 170 fixes the busbars 160 to an accurate position, thereby maintaining a stable electrical connection with the terminal parts 111 of the battery cells 110. The busbar frame 170 may also serve to guide the flow of coolant.

The busbar frame 170 enables effective cooling while ensuring electrical safety. In addition, the busbar frame 170 may provide structural stability and prevent displacement of the busbar 160 due to vibration or impact. The busbar frame 170 may also improve the reliability of electrical connections by stably securing the busbars 160. Maintaining the accurate position of the busbars 160 may thus minimize contact resistance and reduce heat generation. In addition, the structural support of the busbar frame 170 can enhance durability of the entire battery assembly 100 against vibration or impact.

Referring again to FIGS. 48 to 50, a part of the coolant flowing along the second coolant path 150b may flow into the space between the busbar frame 170 and the cell frame 120 and come into contact with the terminal parts 111 and the busbars 160.

A space of a predetermined distance may be formed between the busbar frame 170 and the cell frame 120 according to this aspect. As the coolant passes through this space, it can simultaneously come into contact with the side surface of the terminal part 111 and the lower surface of the busbar 160. A part of the coolant in the second coolant path 150b may flow into this space, and simultaneously cool the terminal part 111 and the busbar 160. This distance may be set to a size that allows the coolant to flow smoothly.

As a result, the terminal parts 111 and the busbars 160 may be simultaneously cooled, thereby improving overall thermal management efficiency. The coolant flow structure enables effective cooling around the terminal part 111 and the busbar 160. Further, by utilizing the space between the busbar frame 170 and the cell frame 120, the cooling performance can be improved without the need for additional cooling channels. By simplifying the structure, it is possible to ensure excellent cooling performance while reducing manufacturing costs.

Referring to FIGS. 48 to 50, a terminal cooling flow path 180 is formed between the busbar frame 170 and the cell frame 120, and a part of the coolant flowing through the second coolant path 150b may flow through the terminal cooling flow path 180.

The terminal cooling flow path 180 according to this aspect may be a channel structure formed between the upper surface of the busbar frame 170 and the lower surface of the top frame 120a. A part of the coolant flowing along the second coolant path 150b may flow into the space between the busbar frame 170 and the top frame 120a (i.e., the terminal cooling flow path 180) through the cooling holes 171 formed in the top frame 120a. The terminal cooling flow path 180 may be formed by branching off from the main flow path of the second coolant path 150b. The coolant may pass through the terminal cooling flow path 180 and directly absorb heat from the terminal parts 111. The terminal cooling flow path 180 may be designed to match the shape of the terminal parts 111. The height and width of the terminal cooling flow path 180 may be optimized for smooth flow of the coolant.

The terminal cooling flow path 180 may effectively remove localized high heat generated in the terminal parts 111. The terminal cooling flow path 180 can enable concentrated and efficient cooling of the terminal parts 111. In addition, it is possible to improve the reliability of the electrical connection part and prevent increased contact resistance. The high heat generated at the terminal parts 111 during charging and discharging can be quickly dissipated, thereby maintaining battery performance. In other words, by lowering the temperature of the terminal parts 111, the reliability of the electrical connections can be improved.

Referring again to FIGS. 48 to 50, one or more cooling holes 171 may be formed in the busbar frame 170, and a part of the coolant flowing through the second coolant path 150b may flow in through the cooling hole 171 to the terminal cooling flow path 180.

The cooling holes 171 according to this aspect may be arranged at regular intervals along the busbar frame 170. For example, a plurality of cooling holes 171 may be arranged in a row along the x-axis of FIG. 49. The cooling holes 171 may be formed to penetrate vertically through the busbar frame 170. The inlet portion of the cooling holes 171 may be formed with a chamfer structure that facilitates inflow of a coolant. The plurality of cooling holes 171 may be arranged at uniform intervals to enable uniform distribution of the coolant. The coolant of the second coolant path 150b may pass through the cooling holes 171 and flow into the terminal cooling flow path 180. Referring to FIG. 50, the coolant that comes into contact with the terminal parts 111 of the battery cells 110 while passing through the terminal cooling flowing path 180 may again merge with the coolant that passes through the second coolant path 150b via the cooling holes 171, such as in the vicinity of the second outlet port 140b. The coolant can then be discharged from the battery assembly 100 through the second outlet port 140b.

The diameter and spacing of the cooling holes 171 may be designed to optimize the coolant flow rate. A simple hole structure allows for an effective cooling system without the need for complex channel designs.

According to another aspect of the present disclosure, a device comprising the battery assembly 100 is provided.

As discussed above, a significant amount of heat is generated at the terminal parts 111, 112 of the battery cells 110 and the busbar members 131 (or busbars 160). Therefore, one aspect of the present disclosure involves supplying coolant at its coldest temperature (i.e., before it has been warmed via contact with other parts of the battery cells 110) to the terminal cooling flow path 300T (or 180) to cool the relatively high temperature terminal parts 111, 112 and busbar members 131 (or busbars 160). In that regard, as discussed above in connection with the aspects illustrated in FIGS. 35-52, the cooling hole 171 that supplies the coolant to the terminal cooling flow path 180 is relatively close to the second inlet port 140a, where coolant that has not yet cooled any battery cells is supplied into the cell frame 120. On the other hand, the coolant supplied to the terminal cooling flow path 300T in the aspects illustrated in FIGS. 13-18 is supplied by coolant at an intermediate point along the cooling flow path 300 between the inlet port 121 and the outlet port 122. Therefore, one modification that could be made to the aspect illustrated in that figure would be to have the inlet port 121 and the terminal cooling hole 124 positioned close to one another. That might be done by, for example, switching the locations of the inlet and outlet ports 121, 122, such that the inlet port 121 is instead positioned above the separating part 120M so that it supplies the first (upper) cooling flow path 300a, and then have the outlet port 122 positioned below the separating part 120M so that the coolant flowing along the second (lower) cooling flow path 300b is discharged through it. Then, the first terminal cooling hole 124a shown in FIGS. 14 and 16 can be relocated to be in close proximity to the inlet port 121, in much the same manner that the cooling hole 171 is relatively close to the second inlet port 140a in the examples illustrated in FIGS. 35-52. In another alternative, the inlet and outlet ports 121 and 122 can remain as shown in FIGS. 1, 3, 7, 17, 26, and 27, except that the first terminal cooling hole 124a can be relocated to the opposite side of the battery assembly along the longitudinal (y-axis) dimension, and then a connecting hole 123 can be provided through the separating part 120M at that location and a connecting pipe 125 for connecting the connecting hole 123 and the first terminal cooling hole 124a may be provided in the same arrangement as shown in FIG. 18. That way, freshly supplied coolant entering the cell frame at its coldest temperature can be directed upwards to the terminal cooling flow path 300T to cool the terminal parts 111, 112 and busbar members 131. It is noted that, in both of the above alternatives, the flow direction along the terminal cooling flow path 300T will be opposite to that shown in FIG. 14, assuming that the inlet and outlet ports 121, 122 remain on the same side of the cell frame 120 along the longitudinal (y-axis) dimension. That is, in the above alternatives, the coolant will instead flow along the cooling flow path 300T in the positive rather than the negative direction along the y-axis.

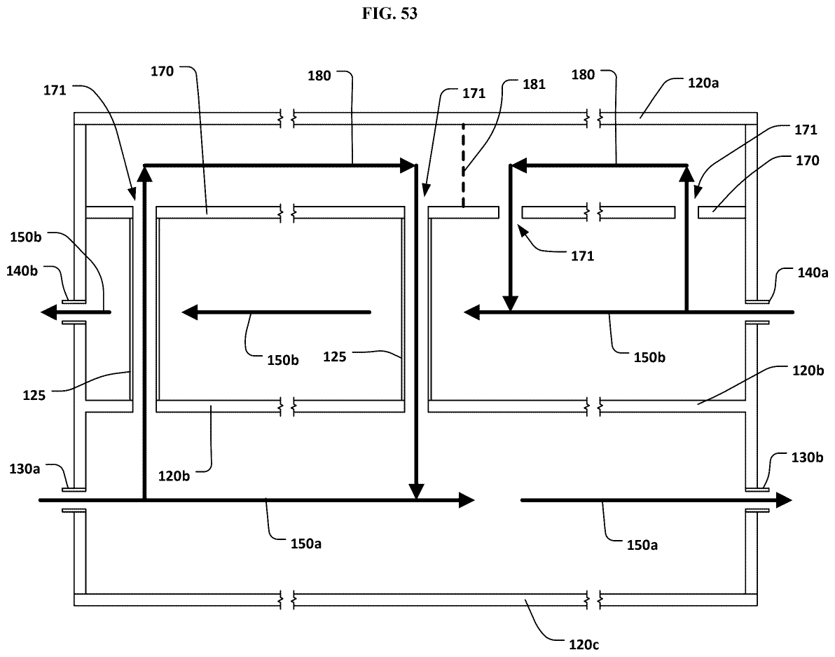

In another alternative, as illustrated in FIG. 53, a modified version of the aspect illustrated in FIGS. 35-52 is shown. Specifically, in the schematic diagram illustrated in FIG. 53, the coolant flow paths at each level, i.e., the first (lower) coolant path 150a (below the separation provided by the middle cell frame 120b) and the second (upper) coolant path 150b (above the separation provided by the middle cell frame 120b) each have a portion of the coolant diverted shortly after entering the cell frame 120 through the respective first and second inlet ports 130a, 140a. That is, shortly after entering the cell frame 120 via inlet port 130a, a portion of the coolant from the first coolant path 150a is diverted upward through connecting pipe 125 to form part of the terminal cooling flow path 180 in the space between the busbar frame 170 and the top cell frame 120a. Likewise, shortly after entering the cell frame 120 via inlet port 140a, a portion of the coolant from the second coolant path 150b is diverted upward through cooling hole 171 in the busbar frame 170 to form another part of the terminal cooling flow path 180 in the space between the busbar frame 170 and the top cell frame 120a. In that way, the coolant provided to cool the busbars 160 and the battery terminal parts 111, 112 is supplied from both coolant paths 150a, 150b just after entering the cell frame 120 through the respective inlet ports 130a, 140a, where the coolant is at its lowest temperature before it has encountered any of the battery cells 110 in the cell frame 120. The arrangement of FIG. 53 also provides more temperature uniformity along the busbars 160 and battery terminal parts 111, 112 by having the coldest temperature coolant supplied at each end of the cell frame 120 along the longitudinal dimension and flowing towards the center along the longitudinal dimension, such that the resulting temperature gradient is warmest in the middle and coolest at each longitudinal end. The coolant from the terminal cooling flow paths 180 is then returned to the respective coolant paths 150a, 150b after it has encountered and cooled the various busbars 160 and terminal parts 111, 112. For example, the passages for returning the coolant from the terminal cooling flow paths 180 to the respective coolant paths 150a, 150b may be positioned at approximately the middle of the cell frame 120 along the longitudinal dimension. That is, with reference to FIG. 53, the terminal cooling flow path 180 moving from left to right is returned to join the first coolant path 150a via connecting pipe 125, and the terminal cooling flow path 180 moving from right to left is returned to join the second coolant path 150b via cooling hole 171. Moreover, in some examples a barrier 181 may be provided to prevent the terminal cooling flow paths 180 flowing towards each other from opposite ends of the cell frame 120 from directly engaging one another. Although, in other examples, no such barrier 181 may be provided, and the cooling flow paths 180 converging towards the middle of the cell frame 120 along the longitudinal dimension may encounter and combine with one another in the same region that the coolant from the terminal cooling flow paths 180 is returned to the first and second coolant paths 150a, 150b.

Another way of supplying fresh coolant at its coldest temperature to the terminal cooling flow path 300T (or 180) to cool the terminal parts 111, 112 and busbar members 131 (or busbars 160) would be to have dedicated inlet and outlet ports that supply coolant from outside the cell frame directly into the space between the top cell frame or the busbar frame and the cell cover, which space defines the terminal cooling flow path 300T or 180, rather than having the coolant travel upward into that space via the terminal cooling hole 124 or the cooling hole 171. It is noted that, even in such a structure with separate inlets and outlets dedicated to directing coolant along the terminal cooling flow path 300T or 180, cooling holes 124 or 171 may still be provided so that the coolant can communicate with the flow path positioned below it.

In yet another alternative, terminal and busbar cooling may be provided even if the remaining coolant that cools the battery cells 110 in the cell frame 120 merely has a single level. For example, if there were one or more inlet ports at one end of the cell frame 120 in the longitudinal dimension and one or more outlet ports at the opposite end of the cell frame 120 in the longitudinal dimension, and the coolant supplied through those ports directly contacted the battery cells 110 along their entire height dimension (i.e., without a separating part 120M dividing the coolant flow paths in the vertical (z-axis) dimension), such that the coolant followed a simple flow path flowing from one end of the cell frame 120 to the other along the longitudinal (y-axis) dimension, terminal and busbar cooling could still be provided in such an arrangement. Moreover, in order to supply the coolant at its coldest temperature into contact with the terminal parts 111, 112 and busbar members 131, a first terminal cooling hole 124a formed in the top cell frame 120a or a cooling hole 171 formed in the busbar frame 171 may be positioned relatively close to the inlet port(s) along the longitudinal (y-axis) dimension.

In the above discussions of alternative ways of supplying coolant at its coldest temperature to the terminal cooling flow path 300T (or 180) to cool the terminal parts 111, 112 and busbar members 131 (or busbars 160), it was disclosed that the cooling hole 124a or 171 that supplies the coolant to the terminal cooling flow path 300T or 180 may be “relatively close” or “in close proximity” to the nearest inlet port through which the coolant enters the cell frame 120. One way of characterizing such closeness would be to say that the cooling hole is located between the inlet port and the first of the batteries along the direction in which the coolant flows along the cell frame 120 from the inlet port (i.e., the y-axis dimension in the examples illustrated in the figures herein). More specifically, the cooling hole may be positioned between the inlet port and the center of the first row of batteries that extends transverse to the flow direction. Alternatively, the cooling hole may be positioned between the inlet port and the closest edge of the first row of batteries extending transverse to the flow direction. Yet another way of characterizing the closeness would be to say that the cooling hole is positioned closer to the end of the end of the cell frame 120 having the inlet port than to the opposite end of the cell frame 120 (e.g., the opposite end of the cell frame 120 from the inlet port along the longitudinal (y-axis) dimension). More preferably, along the dimension in which the coolant flows along the cell frame 120 from the inlet port (i.e., the longitudinal (y-axis) dimension in the figures), the cooling hole may be positioned no more than 25% of the total length of the cell frame 120 away from the inlet port along that flow direction. In another example, the cooling hole may be positioned no more than 20% of the total length of the cell frame 120 away from the inlet port along that flow direction. In yet another example, the cooling hole may be positioned no more than 15% of the total length of the cell frame away from the inlet port along that flow direction. In another example, the cooling hole may be positioned no more than 10% of the total length of the cell frame away from the inlet port along that flow direction. In another example, the cooling hole may be positioned no more than 5% of the total length of the cell frame away from the inlet port along that flow direction. In yet another way of characterizing the closeness of the cooling hole to the inlet port would be to say that the cooling hole is no further from the inlet port along the dimension in which the coolant flows along the cell frame 120 from the inlet port (i.e., the longitudinal (y-axis) dimension in the figures) than a width of one of the battery cells 110 along that same dimension.

In all of the above examples, the reference to a “cooling hole” may be one or more cooling holes. For example, multiple cooling holes may be positioned at the same longitudinal (y-axis) position but spaced apart from one another along the lateral (x-axis) dimension. In another example, multiple cooling holes may also or alternatively be spaced apart along the longitudinal (y-axis) dimension of the cell frame 120. In such case, the reference to the closeness between the cooling hole and the inlet port may be directed to the distance between the closest cooling hole (or group of cooling holes spaced apart along the lateral dimension) and the inlet port along the dimension in which the coolant flows along the cell frame 120 from the inlet port (i.e., the longitudinal (y-axis) dimension in the figures).

In the aspects above, expressions indicating directions such as “front,” “rear,” “left,” “right,” “up,” and “down” have been used. These expressions are used only to facilitate the description, and may vary, for example, depending on the location of a target object or an observer.

One or more battery assemblies according to the aspects described above may be mounted together with various control and protection systems such as a BMS (battery management system), a BDU (battery disconnect unit), and a cooling system, to form a battery pack.

The battery assembly or the battery pack may be applied to various devices, which include, for example, transportation vehicles such as electric bicycles, electric vehicles, and hybrids, and energy storage systems (ESS). However, without being limited thereto, the battery assemblies or the battery pack may be applied to various devices using secondary batteries.

Although preferred aspects of the present disclosure have been shown and described above, the scope of the present disclosure is not limited thereto, and numerous other variations and modifications can be made to the aspects by those skilled in the art using the basic principles of the invention defined in the appended claims. Such variations and modifications also fall within the spirit and scope of the invention.

### Partial List of Reference Numerals

100: battery assembly
110: battery cell
111: terminal part
112: terminal part
120: cell frame
120a: top cell frame
120b: middle cell frame
120c: bottom cell frame
120d: cell cover
130: busbar assembly
131: busbar member
130a: first inlet port
130b: first outlet port
140a: second inlet port
140b: second outlet port
150a: first coolant path
150b: second coolant path
160: busbar
170: busbar frame
171: cooling hole
180: terminal cooling flow path
300: cooling flow path
300a: first cooling flow path
300b: second cooling flow path
300T: terminal cooling flow path

What is claimed is:

1. A battery assembly comprising:
a plurality of battery cells each having a respective terminal;
a cell frame defining an interior space in which the battery cells are received; and
at least one busbar member electrically connected to the terminal of an associated one of the battery cells,
wherein the interior space is configured to receive a coolant circulating therethrough such that the coolant is in direct contact with the battery cells, wherein the cell frame is configured such that at least some of the coolant is directed into direct contact with at least one of the busbar member or the associated terminal.

2. The battery assembly according to claim 1, wherein the cell frame is configured such that the at least some of the coolant is directed into direct contact with both the busbar member and the associated terminal.

3. The battery assembly according to claim 1, wherein the cell frame comprises a top cell frame on which the busbar member is seated and a cell cover located at an upper part of the top cell frame.

4. The battery assembly according to claim 3, wherein a space is defined between the cell cover and the top cell frame, the space providing a terminal cooling flow path configured to direct the at least some of the coolant into direct contact with the at least one of the busbar member or the associated terminal.

5. The battery assembly according to claim 4, wherein the space between the cell cover and the top cell frame includes segments of an adhesive material defining channels therebetween, the channels defining the terminal cooling flow path.

6. The battery assembly according to claim 4, wherein the interior space of the cell frame is configured to direct the coolant into direct contact with the battery cells along a cooling flow path, the interior space of the cell frame being configured such that the cooling flow path and the terminal cooling flow path are connected to each other.

7. The battery assembly according to claim 6, wherein a terminal cooling hole for connecting the cooling flow path and the terminal cooling flow path extends through the top cell frame.

8. The battery assembly according to claim 3, wherein the cell cover comprises a protruding part formed on one surface of the cell cover, and wherein the protruding part protrudes toward a portion where the busbar member and the associated terminal are connected.

9. The battery assembly according to claim 8, wherein the protruding part presses at least a part of the portion where the busbar member and the associated terminal are connected.

10. The battery assembly according to claim 8, wherein the protruding part is fixed by an adhesive to at least a part of the portion where the busbar member and the associated terminal are connected.

11. The battery assembly according to claim 1, wherein the cell frame comprises an inlet through which the coolant flows into the interior space of the cell frame and an outlet through which the coolant is discharged to the outside of the cell frame, the coolant following a flow path between the inlet and the outlet.

12. The battery assembly according to claim 11, wherein the cell frame is configured to direct the coolant to flow along a longitudinal dimension of the cell frame from the inlet.

13. The battery assembly according to claim 12, wherein the cell frame comprises a top cell frame on which the busbar member is seated and a cell cover located at an upper part of the top cell frame, a space being defined between the cell cover and the top cell frame, the space providing a terminal cooling flow path configured to direct the at least some of the coolant into direct contact with the at least one of the busbar member or the associated terminal, wherein the top cell frame includes a terminal cooling hole extending therethrough to divert the at least some of the coolant from the flow path to the terminal cooling flow path through the terminal cooling hole, and wherein the terminal cooling hole is positioned no further from the inlet along the longitudinal dimension of the cell frame than 25% of a length of the cell frame along the longitudinal dimension.

14. The battery assembly according to claim 12, wherein the cell frame comprises a top cell frame on which the busbar member is seated and a cell cover located at an upper part of the top cell frame, a space being defined between the cell cover and the top cell frame, the space providing a terminal cooling flow path configured to direct the at least some of the coolant into direct contact with the at least one of the busbar member or the associated terminal, wherein the top cell frame includes a terminal cooling hole extending therethrough to divert the at least some of the coolant from the flow path to the terminal cooling flow path through the terminal cooling hole, and wherein the terminal cooling hole has a longitudinal position along the longitudinal dimension of the cell frame, the longitudinal position of the cooling hole being between the inlet and a closest battery of the plurality of batteries to the inlet along the longitudinal dimension.

15. The battery assembly according to claim 1, wherein the coolant circulating through the interior space flows within two regions of the interior space that are partitioned from one another.

16. The battery assembly according to claim 15, wherein the two regions of the interior space are partitioned along a longitudinal dimension of each of the plurality of battery cells, such that a first region of the two regions is positioned closer to the terminal of each of the plurality of battery cells along the longitudinal dimension of each of the plurality of battery cells, and a second region of the two regions is positioned farther from the terminal of each of the plurality of battery cells along the longitudinal dimension of each of the plurality of battery cells.

17. The battery assembly according to claim 16, wherein each of the first and second regions includes a respective inlet through which the coolant flows into the respective region from outside of the cell frame, and wherein each of the first and second regions includes a respective outlet through which the coolant is discharged to the outside of the cell frame, such that the coolant flowing through the first region and the second region flow along opposing directions to one another.

18. The battery assembly according to claim 17, wherein both of the first and second regions communicate via a respective passage with a third region partitioned from the first and second regions by a top cell frame, such that the at least some of the coolant can be directed from the first and second regions to the third region so as to come into direct contact with the at least one of the busbar member or the associated terminal.

19. The battery assembly according to claim 1, wherein the plurality of battery cells received within the cell frame are mounted directly to a vehicle or chassis via the cell frame of the battery assembly.

20. A battery pack comprising:
at least one battery assembly as set forth in claim 1;
a pack frame that receives the at least one of the battery assembly and is opened on one side; and
a pack cover that covers the opened one side of the pack frame.
